(19) United States
(12) Patent Application Publication
(10) Pub. No.: US 2013/0239874 A1
(43) Pub. Date: Sep. 19, 2013

(54) ROBUST, ULTRAVIOLET-PROTECTED AMBIENT CONDITION HISTORY INDICATOR AND METHOD OF MAKING SAME

(71) Applicant: TEMPTIME CORPORATION, Morris Plains, NJ (US)

(72) Inventors: Dawn E. SMITH, Martinsville, NJ (US); Brian S. HUFFMAN, Belle Mead, NJ (US); Frederick R. GRABINER, Livingston, NJ (US); Jean-Paul Martin, Brussels (BE)

(73) Assignee: Temptime Corporation, Morris Plains, NJ (US)

(21) Appl. No.: 13/827,898

(22) Filed: Mar. 14, 2013

Related U.S. Application Data
(60) Provisional application No. 61/611,319, filed on Mar. 15, 2012.

(51) Int. Cl. G01N 31/22

(52) U.S. Cl. CPC G01N 31/229
USPC 116/206; 156/60

(57) ABSTRACT

An optically readable ambient condition history indicator can have a substrate, an indicator agent on the substrate surface, and a transparent layer overlying the indicator agent. The indicator agent can be capable of changing appearance in response to exposure to an ambient condition and the transparent layer can be subject to exposure to environmental ultraviolet radiation. The indicator can also include a radiation-filtering adhesive layer overlying the indicator agent to secure the transparent layer to the indicator agent, which adhesive layer can include an adhesive and an ultraviolet radiation filter and can contact both the transparent layer and the indicator agent-bearing substrate. The radiation-filtering adhesive layer can protect the indicator agent from ultraviolet radiation transmitted through the transparent layer and provide a simple, robust construction that is easy to manufacture and resists delamination. The adhesive itself is also protected from ultraviolet radiation. A simplified manufacturing method is also disclosed.

### CROSS-REFERENCE TO A RELATED APPLICATION

This application claims the benefit of provisional patent application No. 61/611,319, filed on Mar. 15, 2012, the entire disclosure of which is incorporated by reference herein for all purposes.

### STATEMENT REGARDING FEDERALLY SPONSORED RESEARCH OR DEVELOPMENT

(Not applicable.)

### BACKGROUND

Some commercial products are perishable and have a limited shelf life that can be adversely affected by undue exposure to heat or other environmental conditions that may occur during storage, distribution, display or other aspects of the life of the commercial product. Ambient condition history indicators can provide a simple visual indication of the cumulative exposure over time of a perishable host product to heat, or to another environmental condition, and can generate a signal indicating the probable condition of the host product. The signal can be an appearance that indicates the host product should be used promptly, checked or, perhaps, discarded.

One useful embodiment of such an ambient condition history indicator comprises a label incorporating an active indicator agent that responds to a target environmental condition and displays a different appearance when a cumulative historical exposure limit is reached. The label can be affixed to the host product, affixed to, or inserted in, packaging for the host product, or can be associated with the host product in other ways, to experience ambient conditions, such as temperature or humidity fluctuations, that are similar to those experienced by the host product. Such labels generally can be economically mass produced for use with consumer products, or with other host products, and may add an insignificant cost to the product.

Ultraviolet radiation (also called “ultraviolet light”) can sometimes interfere with the response provided by the indicator agent leading to an inaccurate signal. For example, in some cases, exposure of an ambient condition history indicator to sunlight, which includes a significant proportion of ultraviolet radiation, may result in a premature indication that a heat exposure limit has been reached because the indicator agent is sensitive to ultraviolet radiation as well as temperature. Exposure to ultraviolet radiation also can occur when perishable host products such as fresh meat or fish are held in a retail display case that is illuminated with fluorescent light, which often includes an ultraviolet component. Accordingly, some known ambient condition history indicators are provided with means to protect the indicator agent from the adverse effects of ultraviolet radiation.

For example, U.S. Pat. No. 7,682,830 to Prusik et al., (Prusik et al. '830) describes, inter alia, a time-temperature indicator system label employing an indicator composition including an active diacetylenic monomer, which composition is protected from deleterious exposure to ultraviolet light by an ultraviolet-absorbent ink composition overlying the indicator composition.

### BRIEF SUMMARY

Some example embodiments of the present invention generally relate to an optically readable ambient condition history indicator useful for monitoring the past exposure of a host product to an ambient condition, for example, heat, and to a method of making the ambient condition history indicator.

Some example embodiments of the present invention include a robust, ultraviolet-protected ambient condition history indicator having a simple configuration that is easy to make.

Some example embodiments include an optically readable ambient condition history indicator including a substrate having a surface and an indicator agent on the substrate surface. The indicator agent can be capable of changing appearance in response to historical exposure to an ambient condition. The appearance change can be irreversible. A transparent layer can overlie the indicator agent and at least a portion of the substrate surface, and can be subject to exposure to environmental ultraviolet radiation. The indicator appearance change can be optically readable through the transparent layer.

The ambient condition history indicator also can include a radiation-filtering adhesive layer overlying the indicator agent that contacts the transparent layer, secures the transparent layer to the substrate surface and extends over the indicator agent. The radiation-filtering adhesive layer can include a contact area above the indicator agent where the radiation-filtering adhesive layer contacts the transparent layer and also contacts the indicator agent. Thus, the radiation-filtering adhesive layer optionally can secure the transparent layer to the indicator agent. Further, the radiation-filtering adhesive layer can include an adhesive and an ultraviolet radiation filter and can filter out ultraviolet radiation transmitted through the transparent layer.
a radiation-filtering adhesive layer overlying the indicator agent, wherein the radiation-filtering adhesive layer contacts the transparent layer, secures the transparent layer to the substrate surface, extends over the indicator agent, and comprises:

The indicator agent can include a polymerizable diacetylenic compound, or another compound, system or device, that can change color irreversibly in response to exposure to an ambient condition, such as temperature, and can exhibit a changed appearance to indicate the elapse of a predetermined cumulative exposure.

Some example embodiments of an ambient condition history indicator described in the present disclosure can solve the problem of providing an ambient condition history indicator with good ultraviolet protection that can be robust, can resist physical abuse such as tampering or aggressive handling, and can be easy to manufacture. Some embodiments of the invention also provide an additional option for varying the level of ultraviolet protection, provided by a given ultraviolet filter material, or materials, by varying the thickness of the radiation-filtering adhesive layer.

Some other example embodiments described in the present disclosure include a method of making an optically readable ambient condition history indicator that includes applying an indicator agent to a substrate surface. The indicator agent can be capable of changing color in response to exposure to an ambient condition. Also, the method can include applying a radiation-filtering adhesive layer to a transparent layer. The radiation-filtering adhesive layer can include an adhesive and an ultraviolet radiation filter and can filter out ultraviolet radiation transmitted by the transparent layer to protect the indicator agent from exposure to the ultraviolet radiation. Further, the method can include overlaying the transparent layer bearing the radiation-filtering adhesive layer on the substrate surface bearing the indicator agent so that the radiation-filtering adhesive layer contacts the transparent layer in or throughout a contact area above the indicator agent.

This method is relatively simple compared with a method of making an ultraviolet-protected ambient condition history indicator that typically includes a step of printing one or more ultraviolet-absorbing ink areas, because such an additional printing step is unnecessary when making embodiments of the claimed invention.

Further example embodiments described in the present disclosure include a new adhesive-coated transparent product provided by the radiation-filtering adhesive layer coated on a transparent member, for example, a transparent layer or film and includes articles or products to which the adhesive-coated transparent product is adhered to provide protection from ultraviolet radiation.

Further example embodiments described in the present disclosure include a method of using an ambient condition indicator embodiment of the invention to monitor past exposure of a host product to an ambient condition which includes associating the ambient condition indicator with the host product so that the ambient condition indicator experiences similar exposure to the ambient condition.

### BRIEF DESCRIPTION OF THE SEVERAL VIEWS OF THE DRAWING

Some example embodiments of the invention, and ways of making and of using one or more example embodiments of the invention, are described in detail herein and by way of example, with reference to the accompanying drawings (which are not necessarily drawn to scale with regard to any internal or external structures shown) and in which like reference characters designate like elements throughout the several views, and in which:

FIG. 1 is a plan view of two known ultraviolet-protected time-temperature indicators arranged side-by-side on a support web;

FIG. 2 is a schematic section on the line 2-2 of FIG. 1 wherein the relative dimensions of the time-temperature indicator are not shown to scale;

FIG. 3 is a schematic sectional view of another example embodiment of a known ultraviolet-protected time-temperature indicator;

FIG. 4 is a view similar to FIG. 3 but of an example embodiment of an ultraviolet-protected ambient condition history indicator according to the invention;

FIG. 5 is a plan view of two of the ambient condition history indicators illustrated in FIG. 4, arranged side-by-side on a support web;

FIG. 6 is a block flow diagram of an illustrative embodiment of a manufacturing method according to the invention for making an ambient condition history indicator;

FIG. 7 shows graphically the results of a light absorbance experiment comparing the light absorbance of an uncoated dyed orange film with the light absorbance of the dyed orange film coated with an ultraviolet-absorbent ink;

FIG. 8 shows graphically the results of a light absorbance experiment comparing the light absorbance of the dyed orange film coated with an ultraviolet-absorbent ink with the light absorbance of the dyed orange film coated with a radiation-filtering adhesive;

FIG. 9 is a view similar to FIG. 4 of another example embodiment of an ultraviolet-protected ambient condition history indicator according to the invention that includes an ultraviolet-absorbing ink layer; and

FIG. 10 is another view similar to FIG. 4 of a further example embodiment of an ultraviolet-protected ambient condition history indicator according to the invention that also includes an ultraviolet-absorbing ink layer.

### DETAILED DESCRIPTION OF EXAMPLE EMBODIMENTS

The term “ambient condition” is used herein to refer to a condition such as temperature, humidity, actinic radiation, X-ray radiation, or the like, that is present in an environment in which an ambient condition history indicator may be located, for example, a storage location, a transport location, a display location or a temporary placement location that a host product may occupy as it is handled during its commercial life from manufacture to end use. Typical ambient temperatures encountered can be below 50° C. (122° F.), although occasional brief excursions above that temperature may occur in some instances.

The term “light” is used herein to include visible and invisible electromagnetic radiation and, more particularly, but not exclusively, to include electromagnetic radiation having a wavelength in the range of from about 200 nm to about 1200 nm, unless the context indicates otherwise.

For convenience, the term “ultraviolet radiation” is used to refer to electromagnetic radiation having a wavelength in the range of from about 200 nm to about 400 nm unless the context indicates otherwise. As a practical matter, the atmosphere filters out most ultraviolet radiation having a wavelength shorter than about 290 nm, sometimes known as “UVC”, so that little radiation in this waveband reaches earth. Accordingly, protection from UVC is generally less important. However, certain devices generate UVC, for example, mercury vapor lamps, germicidal lamps, and some other devices, so that UVC protection sometimes can be useful.

The term “filter” is used herein to include a material that prevents the transmission of some wavelengths of ultraviolet radiation or of visible light through the filter material, regardless of the nature of the prevention mechanism. Thus, a filter herein can block some wavelengths, absorb some wavelengths, scatter some wavelengths, or otherwise interact with incident light to prevent transmission through the filter material of some of the wavelengths included in the incident radiation or light.

The term “color” is used herein to include achromatic visual appearances such as black, gray, and white, as well as chromatic appearances having primary color hues, secondary color hues and/or other color hues, such as, without limitation, red, yellow, green, blue, purple, orange, brown and other hues.

Optically readable ambient condition history indicators are known that include a substrate having a surface and an indicator agent supported on the substrate surface. The ambient condition history indicator can be covered with a protective transparent film and can include means to protect the indicator agent from ultraviolet radiation. The indicator agent can be or can include a condition-sensitive active diacetylenic compound that can change appearance in response to exposure to one or more ambient conditions, for example, heat. Some diacetylenic compounds can provide an irreversible indication of cumulative temperature exposure over time. Other chemistries and technologies also can be used for the indicator agent.

As an example, the ambient condition history indicator can be a time-temperature indicator that can indicate a particular, or predetermined, cumulative heat exposure over time. As the time-temperature indicator is exposed to various temperature conditions, the indicator agent can change appearance, for example, by darkening, until the time-temperature indicator has an optically readable appearance indicating the predetermined dosage has been reached. The color change can be provided by a thermally active, heat sensitive indicator agent that includes a suitable active chemical compound. The active chemical compound can be, for example, a polymerizable diacetylenic compound containing at least two conjugated acetylenic groups, each of which has the formula —C≡C—. The diacetylenic compound, or compounds, can be chosen to respond irreversibly, providing a long-lasting record of the heat exposure, if desired.

Color-changing polymerization of some diacetylene compounds may be initiated by ultraviolet radiation and shorter wavelengths of visible light, for example, wavelengths in the blue end of the visible light spectrum, causing color change independently of exposure to the condition to be monitored.

If the ultraviolet radiation reaches the indicator agent, the ultraviolet radiation can cause the indicator agent to polymerize prematurely, causing the indicator agent to change color and the time-temperature indicator to give an inaccurate signal, for example, a false negative. Therefore, to avoid the risk of premature color development, some time-temperature indicators have been used primarily to monitor host products that are stored in the dark, for example, some light-sensitive pharmaceutical products.

Other ambient condition history indicators employing an active indicator agent that includes an active diacetylenic compound can respond to exposure to other ambient conditions in a comparable manner to a time-temperature indicator. The ambient condition history indicators described herein can be used for various purposes, including for monitoring, or tracking, the cumulative exposure of perishable products to ambient heat. Some examples of perishable products include various medications, vaccines, active medical products containing biologicals, certain foodstuffs, and certain industrial chemical products as well as some other examples described elsewhere herein.

Some ambient condition history indicators, for example, time-temperature indicators, can be mass-produced at high speed and low cost using printing or packaging technology, and can be individually applied to, or associated with, high-volume host products such as vaccines, pharmaceuticals and foodstuffs. Simplicity of manufacture can be important for such applications.

Such known ambient condition history indicators can include a protective film overlying a deposit of an indicator agent and the surface of a supportive substrate, which film is sufficiently transparent that the indicator color change can be read optically through the transparent film. During use, the ambient condition history indicator may be subject to exposure to environmental ultraviolet radiation that is incident upon the transparent film from daylight, fluorescent light in a freezer display case, or the like, or from other sources. This vagrant ultraviolet radiation may cause the ambient condition history indicator to change color prematurely. Such a transparent film can extend over the entire ambient condition history indicator including, for example, a region printed with an active indicator ink, a colored reference area adjacent the active indicator region, and a substrate extending beyond the reference area. The transparent film can be laminated to the substrate and the ambient condition history indicator, using an adhesive, and some example embodiments of the ambient condition history indicator can be configured as a label. The transparent film can be dyed red or orange to filter out undesired shorter visible wavelengths such as wavelengths in the blue portion of the visible spectrum and, possibly, some green wavelengths. However, even if dyed, the transparent film may not filter out undesired ultraviolet radiation.

Accordingly, it is known for the transparent film material to include one or more ultraviolet-filtering compounds to filter out ultraviolet radiation. Such a film can block at least some of the ultraviolet radiation, protecting the active indicator agent.

However, in some cases, such as for longer-term applications, additional ultraviolet protection may be desirable. For example, ambient condition history indicators that are mounted on the outside of host product packages that are to be refrigerated, or to be stored under controlled room temperature conditions, for extended periods, may be periodically exposed to indoor light, or daylight, in locations such as a warehouse or a pharmacy, and additional ultraviolet protection would be useful. Such a need can occur with heat-sensitive pharmaceutical products and other heat-sensitive products having shelf lives of more than a few weeks that may pass through locations such as a warehouse, a pharmacy, other storage facilities, a distribution facility, a handling facility, a transit facility, and so on.

To address this concern, an ultraviolet-absorbent ink containing an ultraviolet-radiation filter, or filters, can be applied as a continuous layer coextensive with the transparent layer to provide additional, or enhanced, ultraviolet protection. However, in this case, a problem of delamination can sometimes arise in long-term applications where an interface between the ultraviolet-absorbent ink and the transparent layer is exposed at the edge of the indicator. This interface may be a weak point which is vulnerable to aggressive handling, abuse, or tampering.

Prusik et al. '830 describes a product shelf life monitoring system comprising a label substrate bearing upon a limited portion of its area an active indicator composition that is protected from ultraviolet light by a visible-transparent, ultraviolet-absorbent composition overlying the indicator composition. The indicator composition is situated within a limited area portion of the substrate surface and the ultraviolet-absorbent composition is at least substantially co-extensive with the indicator composition.

The systems and products described in Prusik et al. '830 appear to be useful for their intended purposes. However, applying a limited area of ultraviolet-absorbent ink involves an additional manufacturing step that can be a drawback for some applications of ambient condition history indicators.

Therefore, it would be desirable to provide a robust ultraviolet-protected ambient condition history indicator that is simple in construction and easy to manufacture.

To solve this problem, some example embodiments of the invention provide an optically readable ambient condition history indicator including a substrate having a surface and an active indicator agent, for example, a diacetylenic compound, on the substrate surface. The indicator agent can change appearance in response to exposure to an ambient condition and can be sensitive to ultraviolet radiation.

The indicator agent can respond to an ambient condition, for example, temperature, humidity, actinic radiation, X-rays, or another ambient condition, that may be experienced by an intended host product during the commercial life of the host product. The indicator agent can display a signal indicating the elapse of a particular cumulative exposure to the ambient condition, which signal can correlate with a change in quality of the intended host product. The cumulative exposure can be a predetermined integral of the exposure to the ambient condition over time. The displayed signal can be an optically readable changed appearance of the indicator agent.

Further, the ambient condition history indicator can include a transparent layer, for example, a transparent film, overlying the indicator agent and the substrate surface. The transparent layer can be subject to exposure to environmental ultraviolet radiation and the indicator appearance can be optically readable through the transparent layer.

The ambient condition history indicator can also include a radiation-filtering adhesive layer overlying the indicator agent. The radiation-filtering adhesive layer can protect the indicator agent from exposure to ultraviolet radiation by filtering out ultraviolet radiation before the ultraviolet radiation reaches the indicator agent. The radiation-filtering adhesive layer can overlie the indicator agent, securing the transparent layer to the indicator agent supported on the substrate, optionally, to the substrate as well, and can contact the transparent layer and the indicator agent. Further, the radiation-filtering adhesive layer can be transparent, enabling the changing appearance of the indicator agent to be read optically through the transparent layer and the radiation-filtering adhesive layer.

Such a radiation-filtering adhesive layer can serve the dual role of performing adhesive functions that contribute to the integrity and strength of the indicator, and of effectively protecting the indicator agent from ultraviolet radiation, without requiring an added layer of ultraviolet-protective ink that could complicate manufacture.

The radiation-filtering adhesive layer can filter out ultraviolet radiation transmitted through the transparent layer and can include various ingredients, for example, an adhesive and an ultraviolet-radiation filter. The presence of an ultraviolet filter in the radiation-filtering adhesive layer can protect the radiation-filtering adhesive layer from ultraviolet-induced degradation.

Optionally, the radiation-filtering adhesive layer can contact both the transparent film and the indicator agent more or less continuously throughout the contact area. Also, the contact area can overlie the entire extent of the indicator agent on the substrate.

The indicator agent can occupy a portion of the substrate surface and the substrate surface can have an unoccupied portion. The unoccupied portion can be used for printed information, another ambient condition history indicator to measure a different ambient condition, or for other purposes. An individual indicator substrate can have multiple occupied portions and multiple unoccupied portions, if desired. The radiation-filtering adhesive layer can also overlie the unoccupied portion or portions of the substrate surface, if desired. Thus, the radiation-filtering adhesive layer can overlie both the occupied and the unoccupied portions of the substrate, if desired. The contact area can be at least coextensive with the portion or portions of the substrate occupied by the indicator agent and, optionally, can extend further.

The transparent layer and the radiation-filtering adhesive layer can extend at least to the periphery of the substrate. Optionally, the transparent film can extend beyond the substrate, and the adhesive layer can extend continuously to the lateral periphery of the transparent film.

The transparent layer can be transmissive to a substantial proportion of the ultraviolet radiation incident on the transparent layer, for example, to at least about 50 percent of the ultraviolet radiation. By way of further example, the transparent layer can transmit at least about 50 percent of the ultraviolet radiation energy in a waveband of from about 200 nm to about 400 nm, or a higher proportion, such as, at least about 70 percent, or at least about 90 percent.

The radiation-filtering adhesive layer can filter out ultraviolet radiation having wavelengths that can cause the indicator agent to change color, for example, ultraviolet-radiation having a wavelength in the range of from about 200 nm to about 400 nm. By way of further example, the radiation-filtering adhesive layer can filter out at least about 70 percent, at least about 90 percent, at least about 95 percent, for at least about 99 percent, of the ultraviolet energy incident on the radiation-filtering adhesive layer in a waveband of from about 200 nm to about 400 nm. The radiation-filtering adhesive layer can filter out higher proportions of ultraviolet radiation incident on the radiation-filtering adhesive layer in some cases, for example, at least about 99.5 percent or at least about 99.9 percent, or at least about 99.95 percent. For some applications, where UVC is unlikely to be encountered, the filtration wavelength range can be from about 290 nm to about 400 nm. The radiation-filtering adhesive layer can filter out ultraviolet radiation in other wavelength ranges according to the expected conditions to be encountered or to the properties of the indicator agent, or both.

Further, the transparent layer can be transmissive to at least about 20 percent of the light energy incident on the transparent layer in a visible light waveband below about 540 nm, for example, a waveband of from about 400 nm to about 500 nm. Optionally, the transparent layer can be transmissive to higher proportions of the incident light energy, such as 50 percent or more. The transparent layer can be highly transmissive to all, or most, wavelengths of visible light, in some cases, for example, transmissive to at least 90 percent of the visible wavelength light energy that is incident on the transparent film.

Optionally, the transparent layer can block some wavelengths of visible light. To this end, the transparent layer can include a light filter to filter out a short wavelength portion of the visible light spectrum. The light filter can be transmissive to visible light having a longer wavelength than the filtered-out short wavelength visible light, for example red light. Optionally, the light filter can also be transmissive to yellow light, and/or orange light. The light filter can be a dye or another colorant, for example, an orange, red, or yellow dye, or other colorant.

The radiation-filtering adhesive layer can include a visible light filter to filter out a substantial proportion of visible light incident on the adhesive layer in a waveband of from about 400 nm to about 500 nm, or to about 540 nm. The proportion of visible light filtered can be the same as one of the proportions of ultraviolet radiation that can be filtered out, as was described previously herein. For example, the radiation-filtering adhesive layer can include a light filter that can filter out some or all of the incident light in the blue waveband, such as visible light having a wavelength of 500 nm, or less. Optionally, the light filter, if employed, can filter out some or all of the incident visible light having a wavelength of 540 nm, or less, including some green wavelengths. The light filter can be transmissive to orange light and, optionally, to longer wavelengths. An example of a suitable blue-light filter is an orange dye. Other examples include a red dye and a yellow dye.

The radiation-filtering adhesive layer can filter out desired wavelengths of both ultraviolet radiation and visible light by including in the radiation-filtering adhesive layer one or more suitable ultraviolet-radiation filters and one or more suitable visible light filters. Long wavelength visible light, for example, visible light having a wavelength above about 600 nm, can pass through the radiation-filtering adhesive layer and be used to read the condition of the ambient condition history indicator, visually or with a suitable optical device or instrument. Some example embodiments of radiation-filtering adhesive layer can be transmissive to visible light having a wavelength above about 540 nm.

The radiation-filtering adhesive layer can have an adhesive strength sufficient to provide integrity to the ambient condition history indicator. Further, the radiation-filtering adhesive layer can have an adhesive strength indicated by a peel value. The peel value can be at least about 8 g/mm as determined at an angle of 90° and a speed of 5 mm/s using a Cheminstruments AR1000 peel tester, or can have another suitable value, such as at least about 16 g/mm.

The transparent layer can be an outer layer of the ambient condition history indicator and can be subject to exposure to ultraviolet radiation received from the environment around the ambient condition history indicator. The indicator appearance can be optically readable through the transparent layer by a human viewer, or by an optical reading device, for example, by a camera.

The radiation-filtering adhesive layer can be sufficiently transparent to enable the ambient condition history indicator to be read optically. For example, the adhesive layer can transmit at least about 70 percent, at least about 90 percent, or at least about 95 percent of light energy reflected from the indicator agent in a waveband of from about 400 nm to about 700 nm.

The substrate, the indicator agent, the transparent layer, and the several components of the radiation-filtering adhesive layer, namely, the adhesive component, the ultraviolet-radiation filter and the visible light filter, if employed, each can be selected from a variety of materials, some examples of which are further described elsewhere herein.

The indicator agent can be or can include an active diacetylenic compound capable of changing appearance in response to cumulative exposure to temperature over time and the ambient condition history indicator can be embodied as a time-temperature indicator.

Some example embodiments of the invention includes a host product wherein the ambient condition history indicator is associated with the host product to monitor the exposure of the host product to an ambient condition.

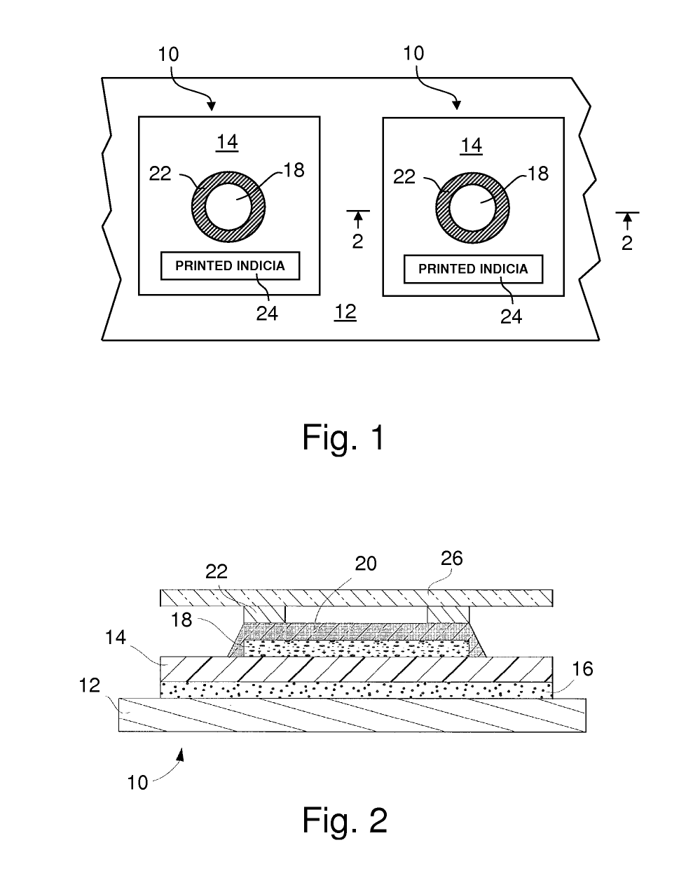

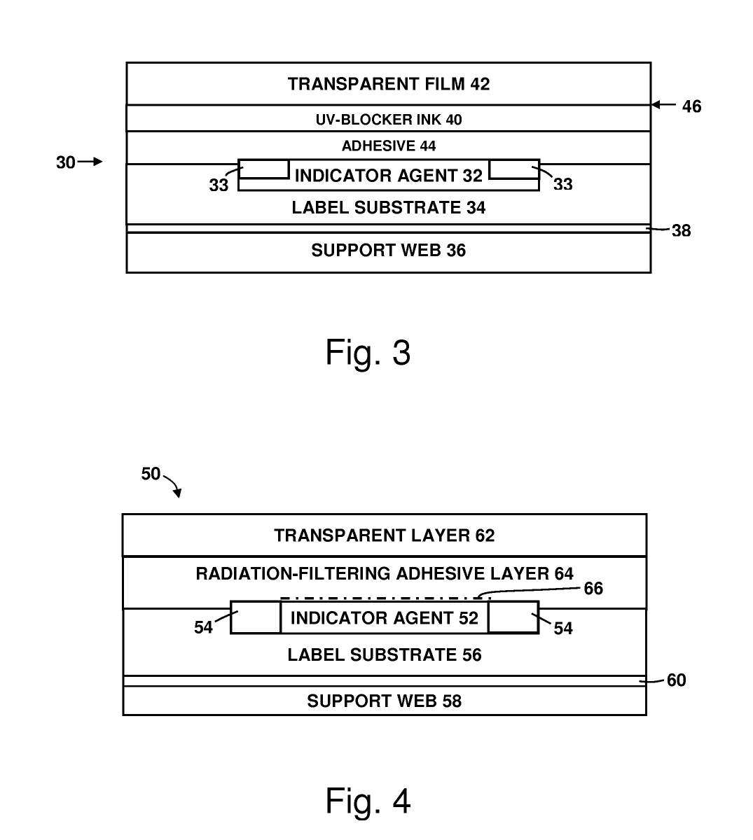

Known time-temperature indicators can be embodied in labels that are self-adhesive and manufactured in roll form for attachment to a host product or to a host product package. The known time-temperature indicator labels shown in FIGS. 1 and 2 herein are generally similar to the time-temperature indicator label (“TTI system label”) described in Prusik et al. '830 with reference to FIGS. 3 and 4 of that patent. Prusik et al. '830 describes product shelf life monitoring systems for monitoring and indicating the elapse of a predetermined integral of ambient conditions such as time, temperature, and other conditions to which such a system has been exposed. One embodiment described in Prusik et al. '830 is a product shelf life monitoring system comprising a label substrate bearing upon a portion of its area an active indicator composition that responds to temperature variations over time with a visible change in color density of the indicator composition. Prusik et al. '830 also describes means to protect the active indicator composition from ultraviolet radiation.

Referring now to FIGS. 1 and 2 of the accompanying drawings, the known time-temperature indicator label illustrated, referenced 10, can be supported on a release sheet which serves as a support web 12. As shown in FIG. 1, a number of time-temperature indicator labels 10 can be arranged in series on a support web 12, a section of which is shown in FIG. 1, for mass production of the labels using print industry technology.

Known indicator label 10 can comprise a self-adhesive label substrate 14, bearing an adhesive layer 16 that removably adheres label substrate 14 to support web 12. Label substrate 14 bears an active indicator spot 18 of an ink composition that includes a thermally sensitive diacetylenic compound. Indicator label 10 can include a visibly transparent ultraviolet-blocking layer 20 (FIG. 2), which can be a printed ultraviolet-absorbent ink, comprising a transparent lacquer composition, disposed directly over active indicator spot 18. The area of ultraviolet-blocking layer 20 can register with the area of active indicator spot 18. Alternatively, ultraviolet-blocking layer 20 can extend somewhat beyond the area of active indicator spot 18, as shown, to avoid difficulties with precise registration during production. This arrangement provides the diacetylenic compound in the active indicator spot with protection from ultraviolet radiation while employing a relatively small amount of ultraviolet-absorbent ink.

A reference ring 22 can be printed on ultraviolet-blocking layer 20 and can be colored to provide a suitable reference against which to compare the appearance of active indicator spot 18. Reference ring 22 can have, for example, an appearance approximating the appearance active indicator spot 18 will develop after a predetermined time temperature exposure indicative of when an intended host product, with which indicator label 10 is associated, may lose utility or potency. Changes in the color density of active indicator spot 18 can be observed through reference ring 22 and ultraviolet-blocking layer 20, as viewed through reference ring 22.

Indicator label 10 optionally can bear printed indicia 24 providing identifying or instructional, or other information. A substantially inert, transparent film 26 can overlie time-temperature indicator label 10 to provide protection from physical abrasion or abuse.

As described in Prusik et al. '830, ultraviolet-blocking layer 20 can include an ultraviolet-blocker ink composition comprising an organic ultraviolet-blocker compound, an inorganic ultraviolet-blocker compound, and a yellow dye. This composition is intended to block short-wavelength visible light as well as ultraviolet radiation. Prusik et al. '830 also describes a fabrication process wherein a continuous web of transparent film bearing an ultraviolet-absorbent, or ultraviolet-blocker, composition is laminated upon the printed, active compound face of the label substrate web. As described, a printing or coating station is situated downstream from a point of active diacetylenic monomer composition application and to effect deposition of an ultraviolet-blocker composition.

Indicator labels 10 can be stored in the dark, at low temperature, until needed, to protect them from premature coloration. When needed, a stock of indicator labels 10 can be withdrawn from cold storage and applied to host product items, or to packages, or other containers, containing one or more host product items, to begin monitoring the heat exposure experienced by the host product. Indicator label 10 can have a disposition on the host product or host product container that is suited to optical reading and permits the indicator label 10 to be exposed to heat conditions similar to those experienced by the host product. During the subsequent commercial life of the host product, active indicator spot 18 is protected by ultraviolet-blocking layer 20. As described in Prusik et al. '830, Ultraviolet-blocking layer 20 can block potentially harmful ultraviolet light and shorter wavelengths of visible light that may be incident on the indicator label 10 from fluorescent lighting, daylight or from other sources, from interfering with the heat monitoring properties of indicator label 10.

The example embodiment of time-temperature indicator shown in FIG. 3, referenced 30, is generally similar to that shown in FIGS. 1 and 2, but differs in that FIG. 3 shows the presence of a layer of adhesive between the transparent film and the label substrate that is not shown in FIGS. 1 and 2.

Referring to FIG. 3, time-temperature indicator 30 includes an area of an active indicator agent 32, surrounded by a colored reference ring 33, both of which are printed on a label substrate 34 that is held on a support web 36 by a layer of pressure-sensitive adhesive 38. A region of ultraviolet blocker ink 40 (“UV-blocker ink 40” in FIG. 3) printed on a transparent film 42 overlies indicator agent 32. Transparent film 42 can be colored orange to filter out blue light to provide additional protection to indicator agent 32. A time-temperature indicator similar to that shown in FIG. 3 is available from Temptime Corporation, Morris Plains, N.J., under the trademark HEATMARKER®.

A layer of laminating adhesive 44 adheres transparent film 42 to label substrate 34. Laminating adhesive 44 also extends between indicator agent 32 and ultraviolet blocker ink 40 adhering the one to the other. Multiple time-temperature indicators 30 can be assembled on a continuous support web 36 and separated into individual units, for example, by die cutting, for application to individual host products or host product containers or packages, if desired. As noted, FIG. 3 is schematic and, the thicknesses, in particular, of the various elements are not to scale. For example, printed indicator agent 32, reference ring 33 and printed ultraviolet-blocker ink 40 can be thinner than shown.

Time-temperature indicator 30 can be manufactured, for example, by printing indicator agent 32, and reference ring 33 on to label substrate 42 while supported on support web 36, and coating a solvent-based ink containing light-blocking and light-absorbing ingredients onto polymeric transparent film 42 to provide a region of ultraviolet blocker ink 40 having ultraviolet-blocking and visible-light-blocking characteristics. After drying, laminating adhesive 44 can be transfer-coated onto the ink-coated side of transparent film 42 and the adhesive-coated transparent film 44 can then be laminated to label substrate 42. The resultant time-temperature indicator 30 can block a substantial, or high, proportion of the ultraviolet radiation incident upon transparent film 42, and of the incident short-wavelength visible light, so as to protect indicator agent 32 from these components of the ambient radiation, which may interfere with the response of indicator agent 32 to heat.

However, in some cases, for example, for long-term monitoring of host products subject to repeated, or aggressive, handling, and for other uses, a more robust indicator of past exposure to temperature or other ambient conditions that has a simple construction and is easy to manufacture could be useful. The inventors of the present application have observed that in some circumstances, the mechanical integrity of time-temperature indicators, such as time-temperature indicator 30, can become impaired over the long term.

In use, a time-temperature indicator such as time-temperature indicator 30, or other ambient condition history indicators may often be located on an exposed outer surface of a host product, or of a package or other container for the host product, with the transparent film outermost, where it is subject to frictional contact with other objects and a risk of contact with sharp objects. The inventors of the present application have observed that the integrity of the bond between the transparent film and the ultraviolet blocker ink in such indicators can sometimes be weak, or become weak. Consequently, the time-temperature indicator may be vulnerable to delamination at the interface between the transparent film and the ultraviolet blocker ink, especially at an edge of the indicator which may be created by die-cutting and separating the indicator from one or more neighbors during mass production. An example of this edge interface is referenced 46 in FIG. 3. Apparently, the ultraviolet blocker ink sometimes may not adhere well to some transparent layer materials when the ambient condition history indicator ages and/or experiences mechanical duress. Thus, some environmental conditions, such as exposure to high temperatures for long periods of time, may cause the ambient condition history indicator to become more sensitive to delamination. Ultraviolet blocker ink 40, can be more brittle than laminating adhesive 40, which can be relatively soft. This relative brittleness may encourage delamination, particularly, but not exclusively, in the case of a flexible ambient condition history indicator adhered to a curved surface of a host product.

Accordingly, a more robust indicator of past exposure to temperature, or to other ambient conditions, that can provide good ultraviolet protection, can be easy to manufacture, and can better resist delamination, would be useful, for some applications.

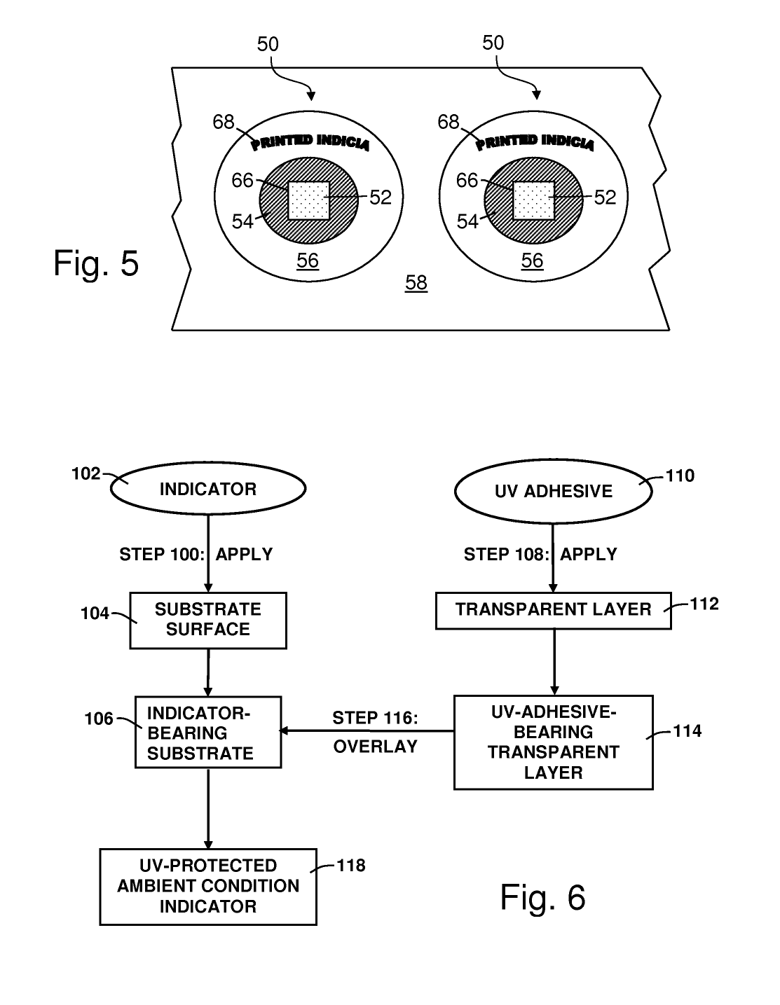

An example embodiment of a robust ambient condition history indicator according to the invention, referenced 50, is shown in FIG. 4, a plan view of which can be seen in FIG. 5. Such an ambient condition history indicator 50 can overcome the problem of vulnerability to delamination. For this purpose, the ambient condition history indicator can employ a radiation-filtering adhesive layer incorporating an ultraviolet-radiation filter and uses the radiation-filtering adhesive layer to bond an outer transparent layer to a label or other substrate bearing an indicator agent, providing a direct connection between the transparent layer, on the one hand, and the substrate and indicator agent on the other hand, that is hard to delaminate.

An added benefit of employing a radiation-filtering adhesive layer, as described herein, is that the ultraviolet-radiation filter, or filters, in the radiation-filtering adhesive layer can also protect the adhesive in the radiation-filtering adhesive layer from ultraviolet-induced degradation, which can sometimes be problematic in long-term use of an ambient condition history indicator.

Referring to FIG. 4, ambient condition history indicator 50 also includes an area of an active indicator agent 52, surrounded by a colored reference zone 54, both of which are printed on, or otherwise applied to a label substrate 56 that is held on a support web 58 by a layer of pressure-sensitive adhesive 60. FIG. 5 shows two ambient condition history indicators 50 arranged side-by-side on support web 58, as they might be disposed for mass production on a continuous strip to yield a roll of ambient condition history indicators 50. Ambient condition history indicator 50, indicator agent 52, reference zone 54, and label substrate 56 can have any desired shape including the shapes shown in FIG. 4. For example, each of indicator agent 52, reference zone 54, and label substrate 56, independently, can be square, rectangular, triangular, hexagonal, polygonal, elongated, circular, oval, elliptical, strip-like, another regular shape, an irregular shape, a shape representing a recognizable image such as a check mark, or another suitable shape.

Label substrate 56 can be fabricated from a material having good affinity for indicator agent 52 so that label substrate 56 can form a strong bond with indicator agent 52 to augment the structural integrity of the ambient condition history indicator 50 and help resist excessive physical handling, or abuse. For example, label substrate 56 can be fabricated from polypropylene sheet or film, for use with an indicator agent 52 that includes an active diacetylenic compound and a cellulose compound, such as nitrocellulose or ethylcellulose, the cellulose compound being the residue from an indicator ink formulation used to print the indicator agent. Other film-formers can be used in the indicator ink, as is known in the art.

The dried diacetylenic indicator ink residue residing on label substrate 56, and constituting indicator agent 52 in this example, can have various proportions of diacetylenic compound, or compounds and film-former, for example, a weight ratio of from about 2:1 to about 1:2, or a weight proportion of one exceeding the weight proportion of the other by not more than about twenty percent.

A suitable ink formulation for a diacetylenic indicator compound is described in Example I of Prusik et al. '830. Other suitable ink formulations are described in U.S. Pat. No. 8,067,483 to Prusik et al.

Indicator agent 52 can have a robust bond to label substrate 56. The bond can be formed in various ways, for example, by applying the indicator agent as a wet indicator ink to a compatible label substrate 56 and drying the indicator ink in-situ. The indicator ink can be formulated to give good film formation and adhesion. Further, indicator agent 52 can be printed as a discontinuous patch in a location on label substrate 56, such as that shown in FIG. 5, where indicator agent 52 is not exposed at the edge of ambient condition history indicator 50, and so is not subject to external delamination forces, unless the indicator has been partially delaminated already. Application of reference zone 54 around indicator agent 52 before lamination can help protect indicator agent 52 from delamination.

The size of ambient condition history indicator 50 can vary according to the application for which it is intended. Some example embodiments of ambient condition history indicator 50 can have a largest transverse dimension (i.e. dimension in the plane of FIG. 5) in the range of from about 5 mm to about 30 mm each, for example, about 10 mm or 15 mm. In such an indicator, reference zone 54 can have a largest transverse dimension of from about 4 mm to about 20 mm, for example, about 8 mm or 10 mm and indicator agent 52 can have a largest transverse dimension of from about 2 mm to about 10 mm, for example, about 4 mm or 6 mm. Ambient condition history indicator 50 can have other dimensions, if desired, for example, to accommodate informational indicia or the like. Depending upon their intended uses, other ambient condition history indicator example embodiments of the invention can have smaller or large configurations.

Ambient condition history indicator 50 can be relatively thin, having a thickness transversely to the plane of the FIG. 5 of less than about 1 mm, or less than about 0.5 mm, or another thickness.

Referring again to FIG. 5, a transparent layer 62, which can be, for example, a self-supporting film of synthetic polymeric or other suitable material, can be laminated to label substrate 56 by a radiation-filtering adhesive layer 64, which extends over indicator agent 52. Transparent layer 62 is transparent in a region above indicator agent 52 and, optionally, can be transparent in additional regions or transparent throughout its entire extent.

Transparent layer 62 can include a light filter to filter out short-wavelength visible light, if desired. For example, transparent layer 62 can include an orange filter to filter out blue light, or a red filter to filter out blue-green light. Transparent layer 62 can be transmissive to red light. A transparent layer 62 that blocks blue light and transmits red light can either block or transmit green light or can block some green light frequencies and transmit others. For example, such a transparent layer 62 can have a transition boundary between blocking and transmission in the green wavelength range of the visible light spectrum. Similar considerations also apply to the yellow wavelength range of the spectrum which can be blocked or transmitted. Nevertheless, transparent layer 62 should transmit sufficient light for indicator agent 52 to be read optically.

Optionally, transparent layer 62 can include an ultraviolet absorber, for example, an organic compound such as azobenzone, and/or an inorganic ultraviolet absorber, to block transmission of ultraviolet radiation through transparent layer 62. However, such a measure may not provide adequate protection from ultraviolet radiation to indicator agent 52, for long-term uses and other uses.

Other characteristics of time-temperature indicator 50, that are not described here, can be similar to time-temperature indicator 10 shown in FIGS. 1 and 2, or to time-temperature indicator 30 shown in FIG. 3, and other characteristics of methods for producing time-temperature indicator 50 can be similar to one of the methods described for producing time-temperature indicator 10 or time-temperature indicator 30, unless this specification indicates differently.

Radiation-filtering adhesive layer 64 can provide adhesion between transparent layer 62, on the one hand, and label substrate 56 and/or one or more elements disposed thereon, for example, indicator agent 52, on the other hand. Also, radiation-filtering adhesive layer 64 can be transparent to permit indicator agent 52 to be viewed or read optically by a suitable device, for example, an image capture device using charge coupled technology. Further, radiation-filtering adhesive layer 64 can provide protection to an element on label substrate 56, or to label substrate 56 itself, from undesired ultraviolet radiation and, optionally, from undesired visible light.

Radiation-filtering adhesive layer 64 can include at least one adhesive so that radiation-filtering adhesive layer 64 has adhesive properties and can bond, or otherwise secure, transparent layer 62 to label substrate 56. Radiation-filtering adhesive layer can contact transparent layer 62 at one edge, at some edges, or at all the edges of ambient condition indicator 50, to help resist delamination.

Radiation-filtering adhesive layer 64 can also include at least one ultraviolet-radiation filter to filter out ultraviolet radiation incident on transparent layer 62 and protect indicator agent 52 from the radiation. Optionally, radiation-filtering adhesive layer 64 can also include a color filter to protect indicator agent 52 from short-wavelength visible light, which color filter, if employed, can supplement, or be an alternative to, any visible light filter that may (or may not) be present in transparent layer 62. Suitable filter materials are further described elsewhere herein. The filter or filters included in radiation-filtering adhesive layer 64 also can protect the adhesive from photodegradation. The filter material or filter materials can be homogenously distributed throughout radiation-filtering adhesive layer 64, for example, as a result of being mixed with other components of radiation-filtering adhesive layer in the liquid state. Solid filter materials, such as metal oxides can be dispersed in particulate form to provide homogeneity. Some example embodiments of ambient condition history indicator 50 employ a transparent layer 62 and a radiation-filtering adhesive layer 64 that both lack a visible light filter.

Longer wavelength visible light, having a wavelength not significantly blocked by the color filter, if such is present, can pass through the radiation-filtering adhesive layer and can be useful for reading the condition of indicator agent 52 by reflection from the surface of indicator agent 52.

Radiation-filtering adhesive layer 64 can be a continuous film or layer extending over the entire area of indicator agent 52, reference zone 54 (if present), and also over label substrate 56. Radiation-filtering adhesive layer 64, can make contact with, and provide a bond between, transparent layer 62, on the one hand, and label substrate 56, on the other hand. Radiation-filtering adhesive layer 64 can also bond with indicator agent 52 and reference zone 54 (if present). The adhesive bond provided by radiation-filtering adhesive layer 64 can extend continuously throughout the areas of indicator agent 52, reference zone 54 (if present), and of label substrate 56, or may be present in one or more portions. Thus, in the example embodiment shown, the volume between indicator agent 52, label substrate 56 and transparent layer 62 is filled with the radiation-filtering adhesive and no other material is present. This construction can provide a good bond between a transparent layer, on the one hand, and a label substrate, and any substrate-disposed components, on the other hand. Moreover, this construction does not include an edge-exposed interface between an ultraviolet-absorbent ink and a transparent layer, such as transparent layer 62, that could be vulnerable to delamination. Accordingly, this construction can resist delamination.

Further, radiation-filtering adhesive layer 64 can extend continuously over the entire areas of a number of label substrates 56 supported on support web 58 during manufacture, if an appropriate manufacturing method is employed, for example, mass production from bulk stock.

In another construction (not shown), radiation-filtering adhesive layer 64 can contact, and provide a bond between, one or more portions of indicator agent 52, and label substrate 56, on the one hand, and a corresponding portion or portions of transparent layer 62, on the other hand throughout a sufficient area, or areas, to provide an adequate seal. Optionally, radiation-filtering adhesive layer 64 can also make contact with a portion, or portions of reference zone 54 (if present). Alternatively, radiation-filtering adhesive layer 64 can contact, and provide a bond between, the entire area of indicator agent 52, and/or reference zone 54, and optionally a portion of label substrate 56, on the one hand, and a corresponding portion or portions of transparent layer 62, on the other hand. Each said portion can be configured as one or more discrete areas, for example, dots, spots, strips, or other limited areas.

Transparent layer 62 can be at least coextensive with radiation-filtering adhesive layer 64, and can extend beyond or outside radiation-filtering adhesive layer 64, if desired. Transparent layer 62 can extend over an entire ambient condition history indicator 50, or over a number of ambient condition history indicators 50 supported on support web 58

As shown in FIG. 4, radiation-filtering adhesive layer 64 extends continuously over the entire area of indicator agent 52, and contacts indicator agent 52 throughout a contact area 66 that is at least coextensive with indicator agent 52. Radiation-filtering adhesive layer 64 also contacts transparent layer 62 continuously throughout a corresponding area (not referenced in FIG. 4) on the opposed surface of radiation-filtering adhesive layer 64. Further, radiation-filtering adhesive layer 64 can be coextensive with transparent layer 62 and can also extend continuously over reference zone 54 and label substrate 56 to the edges of ambient condition history indicator 50.

In FIG. 5, contact area 66 is shown with dots as being limited to indicator agent 52. However, as noted previously, the contact area can extend over the entire label substrate 56, or another suitable area. In this view, transparent film 62 is coextensive with label substrate 58 and accordingly does not appear as a separate element in the figure.

Ambient condition history indicator 50 can also include printed indicia 68, as shown in FIG. 5, for example, instructions for use, and/or advertising. Printed indicia 68 can appear in one or more areas located in any available space on label substrate 56 and can have any suitable form, such as, text, graphics, icons pictures, and the like.

In one example of its use, ambient condition history indicator 50 is formulated to track the cumulative temperature exposure over time of a perishable host product. For this purpose, indicator agent 52 can include a heat-sensitive diacetylenic compound, for example, 2,4-hexadiyn-1,6-bis(ethylurea), as an active indicator compound. Indicator agent 52 can be calibrated for use with a particular host product by selecting a suitable active indicator compound or compounds, in this case 2,4-hexadiyn-1,6-bis(ethylurea). A different compound, or compounds, can be used with a different host product having different temperature-response characteristics. The selection can be made so that the temperature sensitivity of indicator agent 52 over time approximately corresponds with the time-related temperature sensitivity of the host product, enabling a changed appearance of indicator agent 52 to be suitably related to a probable decline in the useful condition of the host product.

For example, the changed appearance can be produced by a cumulative heat exposure such as to be likely to cause the host product to be near the end of its useful life, or to be about to decline in quality. A helpful user instruction such as “use now” or “do not use” can be associated with this indicator agent end point appearance.

A batch of ambient condition history indicators 50 supported on a support web 58 can be stored in a deep freezer, or other suitable storage, depending upon the character of the indicator agent employed, until the indicators are ready to be associated with a host product to begin tracking the heat exposure of the host product. At a point of sale or distribution, or other appropriate location, the ambient condition history indicators 50 can be withdrawn from the deep freezer, or other suitable storage, removed from support web 58, and attached one each to the outer surface of a package containing a host product item.

Subsequently, as the host product is handled during processes such as distribution, stocking, display and, possibly, end user manipulation, the host product can experience a variety of temperature conditions and a variety of lighting conditions. The cumulative effect of the temperature conditions over time can result in a heat exposure that adversely affects the condition of the host product. This heat exposure can be monitored by indicator agent 52.

The lighting conditions experienced by the host product can include exposure to fluorescent light, daylight, or other light sources that include an ultraviolet radiation component that can interfere with the heat response of indicator agent 52, if allowed to reach indicator agent 52. Typical ambient lighting conditions generally include shorter wavelength visible light components, including blue wavelengths, as well as longer wavelength visible light components, including red wavelengths.

At least some of the light incident on transparent film 62 is transmitted through transparent film 62 to become incident on radiation-filtering adhesive layer 64. This transmitted light energy generally includes at least a proportion of the ultraviolet radiation incident on transparent film 62 and can include most, or all of that ultraviolet radiation, if no ultraviolet-radiation filters are present in transparent layer 62.

Radiation-filtering adhesive layer 64 transmits at least some of the visible wavelength incident light energy received, and some or all of the ultraviolet radiation received through transparent film 62 is filtered out by the ultraviolet-radiation filter present in radiation-filtering adhesive layer 64, to prevent the ultraviolet radiation reaching indicator agent 52. Thus, indicator agent 52 is protected from interference with its heat-monitoring response by the ultraviolet radiation.

Radiation-filtering adhesive layer 64 can filter out more or less of the ultraviolet-radiation, according to the concentration and efficacy of the ultraviolet-radiation filter, and the thickness of radiation-filtering adhesive layer 64. This possibility illustrates how the level of ultraviolet protection, and, optionally, the level of visible light protection, provided in an ambient condition history indicator example embodiment of the invention can be changed by varying the concentration of the filtering materials present in the radiation-filtering adhesive layer, or by varying the thickness of the radiation-filtering adhesive layer, or by doing both.

Further, the presence of the ultraviolet radiation filter in radiation-filtering adhesive layer 64, to protect indicator agent 52, can give the adhesive component of radiation-filtering adhesive layer 64 incidental protection from ultraviolet-induced degradation. Similarly, any colorant or light filter included in transparent film 62 or radiation-filtering adhesive layer 64 can help protect the adhesive component from visible-light induced degradation. These capabilities all can be useful in an ambient condition history indicator intended for long-term use or which experiences extended exposure to ultraviolet-containing light from other causes.

Transparent film 62 can include a longer wavelength colorant, for example a yellow colorant, an orange colorant or a red colorant, to filter out at least some of any blue wavelength incident light energy, so that this light energy will not pass through transparent film 62. Transparent film 62 can include an orange colorant to filter out, or block, some shorter visible wavelengths, such as blue wavelengths, and perhaps some green wavelengths, for example, wavelengths of about 540 nm or less. Wavelengths above 540 nm can be transmitted. Also, an orange colorant in transparent film 62 can give ambient condition history indicator 50 an appealing orange appearance.

Even if a suitable colorant is present, transparent film 62 may still transmit some undesired blue wavelength light energy, or other undesired light energy at short visible wavelengths, to radiation-filtering adhesive layer 64. If this short wavelength visible light energy is allowed to reach indicator agent 52 it may interfere with the heat response of indicator agent 52. To prevent this interference, a color filter can be employed in radiation-filtering adhesive layer 64 to filter out short wavelength visible light energy, and further protect indicator agent 52.

Sufficient longer wavelength visible light energy, above about 500 nm, passes through transparent film 62 and radiation-filtering adhesive layer 64, on an incident path and on a return path, and is reflected by indicator agent 52, for a heat-induced appearance change, or changes, of indicator agent 52 to be read optically.

In summary, at least a significant proportion, nearly all, or all, of the ultraviolet radiation component of light energy incident on transparent film 62 can pass through transparent film 62 and then can be filtered out, or blocked, by radiation-filtering adhesive layer 64. Depending upon whether a color filter is present, short wavelength visible light incident on transparent film 62 can be partially filtered out, or blocked, by transparent film 62 and further filtered out, or blocked, by radiation-filtering adhesive layer 64. A significant proportion of long wavelength visible light energy incident on transparent film 62 can pass through transparent film 62, and through radiation-filtering adhesive layer 64, on an incident path, to be reflected or absorbed by indicator agent 52, or by another element on label substrate 56, or by label substrate 56 itself. The reflected light then can pass through transparent film 62 and radiation-filtering adhesive layer 64 on a return path, enabling the appearance of indicator agent 52, or of another element on label substrate 56, or of label substrate 56 itself, to be imaged externally of ambient condition history indicator 50, for example, by being viewed by a human observer.

Ambient heat reaches indicator agent 52, and an associated host product, through normal conductive, convective and radiative processes, and can be accurately monitored by indicator agent 52, which can function without material interference from ambient ultraviolet radiation or, optionally, short wavelength visible light, because of the protection afforded by radiation-filtering adhesive layer, and optionally, transparent layer 62. As the heat is absorbed by indicator agent 52, and indicator agent 52 responds, for example, by gradual polymerization of 2,4-hexadiyn-1,6-bis(ethylurea), or another indicator compound, or compounds, indicator agent 52 can change color, and may exhibit a predetermined appearance in response to a predetermined cumulative heat exposure, being an integral of temperature over time, signaling that an end point has been reached. Indicator agent 52 can change color gradually and progressively in response to continuing heat exposure, in some cases.

The end point indication can be, for example, a change to a dark blue color from a light blue color. Indicator agent 52 can exhibit any other appearance change that can be read optically and is unambiguous, for example a change in hue, and/or a change in intensity and/or a change in lightness. Any color filter that may be present in transparent film 62, or radiation-filtering adhesive layer 64, will modulate the appearance of indicator agent 52 so that, for example, a blue indicator agent viewed through an orange color filter appears gray, and an indicator agent change from light blue to dark blue appears as a change from light gray to dark gray. Desirably, the changed appearance is such as to be unambiguously readable by an ordinary human viewer, without special viewing equipment, at a convenient distance, for example, a distance of a meter. Alternatively, the changed appearance can be read by a camera or another optical device.

The ultraviolet protection provided to indicator agent 52 can be changed by varying the concentration of the ultraviolet-radiation filter in radiation-filtering adhesive layer 64, with higher concentrations of ultraviolet-radiation filter providing greater protection. However, in some circumstances, higher concentrations of ultraviolet-radiation filter may be difficult to formulate into a homogenous adhesive layer. This problem can be solved by increasing the thickness of radiation-filtering adhesive layer 64. The capability to increase the ultraviolet protection by increasing the concentration of the ultraviolet-radiation filter in the radiation-filtering adhesive layer or by increasing the thickness of the radiation-filtering adhesive layer, or by increasing both the concentration and the thickness, is an additional benefit provided by the invention, which provides a variety of ways of tuning the ultraviolet protection afforded to indicator agent 52. Indicator example embodiments with a lower concentration of ultraviolet-radiation filter, or less thickness, can be expected to filter less ultraviolet radiation, and can be useful for some applications.

A thin-layer construction, and proximity to the host product, can enhance the fidelity with which the heat exposure monitored by indicator agent 52 corresponds with the heat exposure experienced by the host product. Also, a thin-layer construction can be conducive to flexibility. A flexible ambient condition indicator can be useful to conform with a curved surface of a host product, or can be easier to manufacture, or handle, in some applications.

An example embodiment of ambient condition history indicator having a thin construction can include: a transparent layer having a thickness in the range of from about 2μ (micron) to about 100μ, or of from about 15μ to about 100μ, for example, about 36μ; a radiation-filtering adhesive layer having a thickness in a range of from about 2μ (micron) to about 100μ, or of from about 10μ (micron) to about 50μ, for example about 25μ; a substrate having a thickness of from about 5μ to about 1 mm, or of from about 10μ to about 100μ, for example, about 25μ; and a layer of indicator agent having a thickness in the range of from about 5μ to about 50μ, or of from about 10μ to about 30μ, for example, about 20μ. One or more of the radiation-filtering adhesive layer, the transparent layer, and the substrate having the thicknesses described can be employed in other constructions of ambient condition history indicator, if desired.

The example embodiment of ambient condition history indicator 50 according to the invention that is shown in FIGS. 4 and 5 illustrates how an ultraviolet-radiation filter can be incorporated into a pre-existing element of an ambient condition history indicator, namely an adhesive layer that is useful to join components together, which element has its own utility apart from the ultraviolet-blocking function. This example embodiment is simple to manufacture, provides protection from ultraviolet radiation without adding a structural element to provide that protection, and can have a variety of configurations and constructions, only some of which are described herein. Ambient condition history indicator 50 employs a simplified construction that avoids having to provide ultraviolet-radiation blocking components in a separate indicator element such as ultraviolet-blocking layer 20, in the known construction shown in FIG. 3, to provide enhanced ultraviolet protection.

Further, FIG. 4 illustrates how an ambient condition history indicator can be configured with a robust construction by employing an adhesive layer to attach the transparent layer directly to the indicator agent, and can be protected by including an ultraviolet-radiation filter in the adhesive layer. Such a construction can exhibit good internal strength, with a good bond between the transparent layer and the substrate bearing the indicator agent, to resist delamination.

Further, such an ambient condition history indicator can be configured without employing an ultraviolet-blocking ink layer, or a deposit of ultraviolet-blocking ink, or another ancillary ultraviolet-blocking element between the adhesive and the transparent film, yet protect an indicator agent from ultraviolet radiation. In some cases, the ultraviolet protection provided can be greater than in known constructions of time-temperature indicator where an ultraviolet-blocking component is incorporated in a protective transparent outer film extending over an active time-temperature indicator element.

In addition, such an ambient condition history indicator can be fabricated by a simple manufacturing method wherein radiation-filtering adhesive layer 64 is applied to transparent layer 62, for example, by coating the radiation-filtering adhesive layer on to the transparent film. The coated transparent film can then be applied to a label substrate bearing an indicator agent and secured thereto by the radiation-filtering adhesive layer. This method avoids a need for an additional step of printing an ink containing an ultraviolet-radiation filter on to one of the layers of the ambient condition history indicator to obtain enhanced ultraviolet protection, as is the case in the method described in Prusik et al. '830.

FIG. 5 illustrates how multiple ambient condition history indicators 50, two of which are shown, can be arranged on a support web 58. Support web 58 can be, for example, a release sheet drawn from a roll of stock material on which a series of ambient condition history indicators is arranged during mass production.

A manufacturing method that can be used to make an optically readable ambient condition history indicator such as ambient condition history indicator 50, and which is adaptable for mass production of large numbers of ambient condition history indicators, is illustrated in FIG. 6. The method shown also can be used to make other ultraviolet-protected indicators or other ultraviolet-protected products, as will be known or apparent to a person of ordinary skill in the art, in light of this disclosure, or will become known or apparent in the future, as the art develops. The method includes a number of steps, which can be performed in any sequence that yields a useful product.

Referring to FIG. 6, the illustrated method can include a step 100 of applying an indicator agent 102, labeled “indicator” 102 in FIG. 6, to a substrate surface 104, yielding an indicator-bearing substrate 106. The method can further include a step 108 of applying a radiation-filtering adhesive 110 to a transparent layer 112, yielding an ultraviolet-adhesive-bearing transparent layer 114. Ultraviolet-adhesive-bearing transparent layer 114 can be a dyed synthetic polymeric film, colored orange or another suitable color, or can be another suitable material. Radiation-filtering adhesive 110 can filter ultraviolet radiation and, optionally, shorter wavelength visible light, and is labeled “UV adhesive 110” in FIG. 6. Radiation-filtering adhesive 110 can be applied as a layer, or as a discrete area or areas.

The illustrated method further includes a step 116 of overlaying ultraviolet-adhesive-bearing transparent layer 114 on indicator-bearing substrate 106 to produce an ultraviolet-protected ambient condition history indicator 118. Step 116 can be performed so that the radiation-filtering adhesive 110 overlies indicator agent 102 and contacts transparent layer 112 in a contact area above the indicator agent 102, for example, by arranging that indicator agent 102 contacts transparent layer 112 throughout the contact area.

Ambient condition history indicator 118 can have any of the characteristics of ambient condition history indicator 50, or other ambient condition history indicator example embodiments of the invention that are described herein. Also, the method illustrated in FIG. 6 can be modified to make an ambient condition history indicator in ways that will be known or apparent to a person of ordinary skill in the art, in light of this disclosure, or will become known or apparent in the future, as the art develops.

In practicing the illustrated method, light-blocking components to block ultraviolet radiation, and optionally to block visible wavelengths, can be incorporated directly into radiation-filtering adhesive 110, instead of applying an ink layer between transparent layer 112 and indicator agent 102 as is described in Prusik et al. '830. Radiation-filtering adhesive 110 can be fabricated off-line, possibly by a supplier, keeping the in-line operations simple. Also, the radiation-filtering adhesive 110 containing light blocking components can be coated directly onto transparent layer 112, providing a simpler manufacturing process than the process described in Prusik et al. '830 wherein an ultraviolet-blocking ink is deposited in a separate step.

The method illustrated in FIG. 6 can be adapted for mass production in various ways, for example, as noted above, by assembling multiple ambient condition history indicators 118 on a support web. Multiple ambient condition history indicators can be fabricated as self-adhesive labels, in a repetitive printing operation, upon a continuous web of release sheet-backed label substrate moving past a number of printing stations, or composition application stations, where the several fabrication steps described with reference to FIG. 6 are performed. Additional printing stations, or print-process devices, can be included to apply printed indicia, reference color markings, use instructions, and/or advertising, or for other purposes.

### Substrate

A substrate employed in ambient condition history indicator example embodiments of the invention can be fabricated from a material that can receive and support the indicator agent and provide a structural base for the ambient condition history indicator. For example embodiments of ambient condition history indicator according to the invention that employ an indicator agent formulated as a printable ink, the substrate can be fabricated from an imprintable material, for example, a synthetic plastic sheet or film. A substrate material for which the indicator agent has good affinity can help securely bind the indicator ink to the substrate, enhancing the structural integrity of the ambient condition history indicator.

Some examples of useful substrate materials include, without limitation, polyethylene, polypropylene, polycarbonate, polyester, polyamide, polyurethane, polyvinyl chloride, polyvinylidene chloride, cellulose-derived materials, aluminum foil, paper, coated paper, and a laminated structure including a layer or layers of any one or more of the foregoing materials.

The substrate can be flexible or rigid and can be transparent or opaque, and optionally can be colored. One example of a suitable substrate material is a corona-treated, dimensionally stable, flexible, white, opaque polyolefin film such as is supplied under the trademarks FASSON® PRIMAX®, product code 250, by Avery Dennison Corporation, Pasadena, Calif.

### Indicator Agent

An indicator agent employed in ambient condition history indicator example embodiments of the invention can include an active compound, for example, a diacetylenic compound, that can be sensitive to one or more ambient conditions to be monitored, that can provide a useful indicator response to an ambient condition, and that also can be sensitive to ultraviolet radiation. Mixtures of two or more such active compounds can also be employed.

### Diacetylenic Compounds.

A condition-sensitive diacetylenic compound employed in an ambient condition history indicator example embodiment of the invention can be any diacetylenic compound capable of responding to exposure to an environmental condition with an optically readable indication, such as a visual appearance change, that enables the condition to be indicated or monitored. The appearance change can be, for example, a change in color, intensity or lightness of the indicator compound or compounds. For example, the diacetylenic compound may darken in color. A given indicator agent can include more than one such diacetylenic compound.

The response can be cumulative over time so that, for example, the diacetylenic monomer can monitor heat exposure as an integral of temperature exposure over time. Desirably the response is irreversible so as to provide a long-lasting indication of the exposure monitored. The diacetylenic compound can polymerize to provide the optically readable indication. Diacetylenic compounds useful as diacetylenic monomers in the practice of some example embodiments the present invention can respond to heat, humidity, ambient atmospheric chemical composition, environmental pressure, ambient radiation, or another ambient condition or to a combination of two or more of these parameters. For example, the diacetylenic compound can be heat-sensitive and can have useful indicator reactivity at temperatures below 50° C., including temperatures of 37° C. (99° F.), 25° C. (77° F.), 20° C. (68° F.), and other temperatures below 50° C. The diacetylenic compound also can be sensitive to interfering radiation such as ultraviolet radiation, which can confuse the response of the diacetylenic compound to a target ambient condition. The interfering ultraviolet or other radiation can be filtered out in ambient condition history indicator example embodiments of the invention.

Some examples of useful diacetylenic compounds are disclosed in U.S. Pat. Nos. 3,999,946; 4,189,399 and 4,384,980 to Patel; U.S. Pat. Nos. 4,789,637 and 4,788,151 to Preziosi et al.; U.S. Pat. Nos. 6,924,148; 7,019,171; 7,161,023; and 8,067,483 (“U.S. Pat. No. 8,067,483”) to Prusik, or Prusik et al.; U.S. Patent Application Publication No. 2009/0131718 by Baughman et al. (“US 2009/0131718”); and U.S. Patent Application Publication No. 2011/0086995 (“US 2011/0086995”) by Castillo Martinez et al. The disclosures of each of these patents and patent application publications are incorporated by reference herein. Optionally, a useful indicator agent can comprise one or more diacetylenic compounds and a reactivity-enhancing adjuvant, for example, as described in U.S. Pat. No. 8,067,483.

More particularly, but not exclusively, the disclosures of Patel U.S. Pat. No. 3,999,946 at column 4, line 13, to column 5, line 48 and of Preziosi et al. U.S. Pat. No. 4,788,151 at column 3, line 58, to column 4, line 62, are incorporated by reference herein. In disclosures incorporated, references to “the invention,” “preferred,” “preferably” and the like are to be understood to refer to the invention of the respective patent or patent application publication from which the text is incorporated, rather than to the invention described herein.

Useful in the practice of example embodiments of the present invention are polymerizable diacetylenic compounds, sometimes called “monomers,” of structural formula

R¹C≡C—C≡CR²

wherein R¹ and R² can be the same or different, and each of R¹ and R² is an organic group compatible with providing the irreversible appearance change. For example, each R¹ and R², independently, can be an alkyl, an aryl, a benzoate, a sulfonate, a urethane, an alkylurea, an acid, or an alcohol group and, optionally, can have up to 20 carbon atoms. Any alkyl group in R¹ or R², considered independently, can be straight-chain or branched, and optionally can be saturated.

Some further examples of useful diacetylenic compounds include polymerizable diacetylenic compounds having the structural formula

R³HNCONH—R⁴—C≡C—C≡C—R⁴—NHCONHR³

wherein each R³ independently is a branched or straight-chain, saturated alkyl group having from 1 to 20 carbon atoms, optionally, ethyl, propyl, butyl, octyl, dodecyl or octadecyl, and R⁴ is alkyl having from 1 to 10 carbon atoms, for example, methylene, ethylene, propylene or butylene.

Another exemplary group of polymerizable diacetylenic compounds useful in the practice of example embodiments of the present invention includes substituted 2,4-hexadiyn-1,6-bis(alkylurea) compounds wherein the alkyl group has from 1 to 20 carbon atoms, the foregoing diacetylenic bis(alkylurea) compounds wherein the alkyl substituents are linear, and co-crystallized mixtures of any two or more of the foregoing bis(alkylurea) compounds. The two alkyl groups in any of the foregoing diacetylenic bis(alkylurea) compounds can be the same and the bis(alkylurea) compounds can be symmetrically substituted, or the two alkyl groups can be different. Some particular examples of the foregoing diacetylenic bis(alkylurea) compounds include ethyl, propyl, butyl, octyl, dodecyl and octyldecyl-substituted 2,4-hexadiyn-1,6-bis(alkylurea) compounds, linear isomers of these compounds and co-crystallized mixtures of the linear isomers. A crystallized diacetylenic compound as described and claimed in US 2009/0131718 can also be employed.

Some further examples of polymerizable diacetylenic compounds that can be employed in the practice of example embodiments of the present invention include: 2,4-hexadiyne-1,6-diol-bis-p-toluene sulfonate; 2,4-hexadiyne-1,6-diol-bisphenylurethane; 2,4-hexadiyne-1,6-diol-bisethylurethane; 2,4-hexadiyne-1,6-diol-bis-n-butylurethane; 7-phenyl-2,4-heptadiyne-1-ol-ethylurethane; 3,5-octadiyne-1,8-diol-bisethylurethane; 5,7-dodecadiyne-1,12-diol-bismethylurethane; and 5,7-dodecadiyne-1,12-diol-bisphenylurethane.

Further, mixtures of any two or more of the diacetylenic compounds described herein can be employed, if desired. The mixtures can be simple admixtures or co-crystallized mixtures. Some co-crystallized mixtures of diacetylenic bis(alkylurea) compounds that can be employed include mixtures of two diacetylenic bis(alkylurea) compounds that differ by a single carbon atom in each of their two alkyl substituents, i.e. one of the two compounds has one more carbon atom in each of its two alkyl sub substituents than does the other compound.

Some particular examples of such co-crystallized mixtures include a co-crystallized mixture of 2,4-hexadiyn-1,6-bis(ethylurea) and 2,4-hexadiyn-1,6-bis(propylurea). The mixed diacetylenic bis(alkylurea) compounds can be present in the mixture in any suitable proportion. For example, the relative proportion of 2,4-hexadiyn-1,6-bis(ethylurea), or another diacetylenic compound having an alkyl group with an even number of carbon atoms, to 2,4-hexadiyn-1,6-bis(propylurea), or another diacetylenic compound having an alkyl group with one more carbon atom, can be a ratio in the range of from about 3:1 to about 1:1 by weight, such as 2:1 by weight or 1:1 by weight.

A co-crystallized solid diacetylenic monomer composition as described in US 2011/0086995 can also be employed.

In addition to a diacetylenic compound, if employed, the indicator agent can include a reactivity-enhancing adjuvant for the diacetylenic compound, if desired, for example, a reactivity-enhancing adjuvant as described in U.S. Pat. No. 8,067,483. As can be understood from U.S. Pat. No. 8,067,483, an indicator agent having ambient temperature reactivity useful in the practice of example embodiments of the present invention can include, or be provided by, a diacetylenic compound that is inactive at temperatures typical of a host product's ambient environment, such as at temperatures below about 50° C., and a suitable reactivity-enhancing adjuvant.

For example, an indicator agent can include 5,7-dodecadiyn-1,12 diol bis(n-octadecyl urethane); 2,4-hexadiyn-1,6-diol bis(phenylurethane); 2,4-hexadiyn-1,6-diol bis(p-methoxybenzene sulfonate); 9-(N-carbazolyl)-5,7-nonadiyn-1-ol phenylurethane; o,o′-diacetylenyldiphenyl glutarate; 2,4-hexadiyn-1,6-diol-bis-p-toluene sulfonate; or 2,4-hexadiyn-1,6-diol-bis-(p-chlorobenzene sulfonate); together with a polymerization initiator and, optionally, a polymerization accelerator.

Some examples of polymerization initiators that can be employed with any of the diacetylenic compounds described herein include highly reactive polymerization initiators, azonitriles, alkyl peroxides, peroxyesters, hydroperoxides, acyl peroxides, ketone peroxides, peroxyketals, peroxydicarbonates, redox initiators, photosensitive polymerization initiators, and mixtures of two or more compatible ones of the foregoing polymerization initiators.

Some examples of polymerization accelerators that can be employed with any of the diacetylenic compounds described herein, together with a polymerization initiator, include transitional metal ions, cobalt, iron, manganese, vanadium, calcium, lithium, potassium, cerium, rare earth, zinc, zirconium and strontium ions, and mixtures of the foregoing metal ions.

Other compounds, materials, or devices, that are sensitive to one or more ambient conditions to be monitored, that provide a useful indicator response to an ambient condition, and that are also sensitive to ultraviolet radiation, can be employed as active indicator agents, or active indicator agent components, in ambient condition history indicator example embodiments of the invention, as alternatives to, or in addition to, the diacetylenic compounds described herein, if desired.

Some compounds that can be employed as, or in, an indicator agent in an ambient condition history indicator example embodiment of the invention include: dyes that can be activated or de-activated by exposure to ultraviolet radiation to provide or remove color, or provide another visible response; dyes that are triggered to exhibit color, or change color, by pH changes, where the dye molecule is also sensitive to ultraviolet radiation. Some examples are disclosed in U.S. Pat. No. 4,917,503 to Bhattacharjee, which describes a photoactivated time-temperature indicator based on a leuco base system. The entire disclosure of U.S. Pat. No. 4,917,503 is incorporated by reference herein. Another compound that can be employed as, or in, an indicator agent in an ambient condition history indicator example embodiment of the invention is a reversibly photochromic compound, particularly, but not exclusively, a compound that can undergo photo-induced coloration by irradiation with light or ultraviolet radiation, followed by a time- and temperature-dependent decoloration, for example, a spiroaromatic compound. Some spiroaromatic compounds and their use in time-temperature indicators, are described in U.S. Patent Application Publication No. 2010/0034961 by Tenetov et al. (“US 2010/0034961”), the entire disclosure of which is incorporated by reference herein. A radiation-filtering adhesive, as described herein, and optionally, a transparent film, as described herein can be employed in time-temperature indicators employing spiroaromatic compounds such as are described in Tenetov et al. to protect the colored spiroaromatic compound from photobleaching or photodegradation by ultraviolet radiation and/or by short-wavelength visible light.

An enzyme-based ambient condition history sensor that is sensitive to ultraviolet radiation can also be employed in, or as, an indicator agent in an ambient condition history indicator example embodiment of the invention, for example, an enzyme-based sensor, such as is described in U.S. Pat. No. 6,642,016 to Sjoholm, et al. or U.S. Pat. No. 4,284,719 to Agerhem, et al.

Some additional compounds and compositions that can monitor an ambient condition history, are sensitive to ultraviolet radiation, and can be employed in, or as, an indicator agent in an ambient condition history indicator example embodiment of the invention are described in U.S. Pat. No. 5,622,137 to Lupton et al., U.S. Pat. No. 5,756,356 to Yanagi, et al., U.S. Pat. No. 6,043,021 to Manico et al., and International Publication No. WO 99/39197 by Haarer et al.

Further suitable compounds, materials, or devices, that can be employed in, or as, an indicator agent in an ambient condition history indicator example embodiment of the invention will be known or apparent to a person of ordinary skill in the art, in light of this disclosure, or will become known or apparent in the future.

### Transparent Layer

A transparent layer employed in ambient condition history indicator example embodiments of the invention can be fabricated from any suitable transparent material, for example, a clear synthetic plastic material, which optionally can be self-supporting, flexible, and/or imprintable. Multiple substrates for multiple ambient condition history indicators can be provided by an extended sheet or continuous film of a suitable material such as a flexible, imprintable synthetic plastic material. Suitable materials for the transparent layer include, and are not limited to, polyethylene, polypropylene, polycarbonate, polyester, polyamide, polyurethane, polyvinyl chloride, cellulose, and the like, and laminates including one or more of the foregoing materials. The outer surface of the transparent layer can be untreated, or can be treated to enhance printability, if desired. The inner surface of the transparent layer can be treated to enhance adherence of the radiation-filtering adhesive layer, if desired.

### Radiation-Filtering Adhesive Layer

The radiation-filtering adhesive layer can include an adhesive component, an ultraviolet radiation filter, and, optionally, a visible light filter. The radiation-filtering adhesive layer can consist of these materials alone or can include one or more other materials that do not interfere with the useful properties of the radiation-filtering adhesive layer, or of ambient condition history indicator 50, for example, tackifiers, transparent extenders or diluents and the like. For manufacture, the radiation-filtering adhesive layer can be formulated as a liquid composition suitable for coating on the ambient condition history indicator, on the transparent layer, or on the ambient condition history indicator substrate and the indicator agent, employing a suitable solvent or mixture of solvents. The solvent or solvents can partially evaporate during manufacture and the end-product ambient condition history indicator can include a residual quantity of the solvent or solvents in the radiation-filtering adhesive layer.

The radiation-filtering adhesive can be present as a discrete layer, or other configuration, in the ambient condition history indicator, distinct from any of the transparent layer, the substrate, the indicator agent, the color reference zone, if present, and other components of the ambient condition history indicator. The radiation-filtering adhesive layer can have a pair of opposed adhesive surfaces, each of which adheres to another component of the ambient condition history indicator, joining the other components together.

Desirably, the radiation-filtering adhesive layer can be free of ingredients that could interfere with the performance of ambient condition history indicator example embodiments of the invention. For example, for an ambient condition history indicator configured to monitor heat, the radiation-filtering adhesive layer can be free of, exclude, or lack, any ingredient intended to absorb infrared energy. For example, for this application, the radiation-filtering adhesive layer can be free of, or exclude, or lack, a dye such as a phthalocyanine, or another material that can absorb infrared energy, particularly near-infrared energy in the 700 nm to 1200 nm waveband.

### Adhesive Component.

An adhesive component of a radiation-filtering adhesive layer employed in ambient condition history indicator example embodiments of the invention can include any suitable adhesive, for example, a synthetic monomer adhesive, a synthetic polymer adhesive, a solvent-based adhesive, a polymer dispersion adhesive, a pressure-sensitive adhesive, a contact adhesive, a hot-melt adhesive, a multi-component adhesive, a heat-curing adhesive, a moisture-curing adhesive, another suitable adhesive, or a mixture of any two or more compatible ones of the foregoing adhesives.

Some examples of suitable adhesives include, and are not limited to, acrylonitrile, cyanoacrylate, acrylic, acrylic copolymer, ethylene-vinyl acetate, polyvinyl alcohol, polyvinyl acetate, polyvinyl chloride, polyvinyl chloride emulsion, styrene acrylic copolymer, phenol formaldehyde resin, polyamide, polyester, epoxy, polyethylene, polypropylene, polysulfide, polyurethane, aliphatic resin, polyvinylpyrrolidone, urea-formaldehyde, starch, latex, resorcinol, silicone adhesives and mixtures of any two or more compatible ones of the foregoing adhesives.

The adhesive component also can include one or more optional ingredients or additives that are compatible with the objects of the invention, for example, one or more tackifiers, such as wood rosin or a polyester, one or more antioxidants, and/or one or more fibrous or nonfibrous fillers.

Some example embodiments of ambient condition history indicators, as described herein, can also include a dried radiation-filtering adhesive layer that can have a non-tacky outer surface which can serve as the outer surface of the indicator rendering unnecessary any additional transparent layer, such as transparent layer 62.

### Ultraviolet-Radiation Filter.

A variety of materials are suitable for use as ultraviolet-radiation filters in the practice of example embodiments of the invention including both organic and inorganic compounds. Sometimes in the art, organic compounds that filter ultraviolet radiation are referenced as ultraviolet radiation absorbers and inorganic compounds that filter ultraviolet radiation are referenced as physical blockers. Organic and inorganic ultraviolet-radiation filters, respectively, generally have peak filtering properties in different parts of the ultraviolet spectrum. Accordingly, some example embodiments of the invention employ at least one organic ultraviolet-radiation filter and at least one inorganic ultraviolet-radiation filter to provide broad-spectrum protection from ultraviolet radiation.

Some useful inorganic ultraviolet-radiation filters include zinc oxide, titanium dioxide and iron oxides. For manufacture, such inorganic filter materials can be employed as dispersions of solid particles in a suitable liquid carrier, or in a liquid component of the radiation-filtering adhesive layer, for example, the adhesive component. The inorganic filter particles can be small enough to provide a transparent dispersion, for example, by having an average particle size of not more than about one micron, not more than about 200 nm or of not more than about 50 nm. The liquid carrier for the inorganic filter material, if employed, can be relatively more volatile to evaporate during manufacture of the ambient condition history indicator, or can be relatively less volatile and can be incorporated into the radiation-filtering adhesive layer.

Some groups of organic compounds that are suitable as ultraviolet-radiation filters include various cinnamates, benzophenones, and salicylates.

Some examples of suitable organic ultraviolet-radiation filter compounds include octylmethoxy cinnamate (also known as 2-ethylhexyl p-methoxycinnamate, and sometimes referenced by the abbreviation “OMC”), octyl salicylate, octocrylene, oxybenzone, 2-ethylhexyl N,N-dimethylaminobenzoate, p-aminobenzoic acid, 2-phenyl-benzamidazole-5-sulfonic acid, homomethyl salicylate, avobenzone, DEA p-methoxycinnamate, octylmethoxy cinnamate, 4/4′-methoxy-t-butyldibenzoylmethane, 4-isopropyldibenzoylmethane, 3-(4-methylbenzylidene) camphor, 3-benzylidene camphor, 4-N,N-dimethylaminobenzoic acid ester, 2,4-dihydroxybenzophenone, 2-hydroxy-4-(2-hydroxyethoxy)benzophenone, 4-hydroxydibenzoyl-methane, 4-(2-hydroxyethoxy)dibenzoylmethane, 4-N,N-di(2-ethylhexyl)-aminobenzoic acid ester, 4-N,N-(2-ethylhexyl)methylaminobenzoic acid ester, 4-N,N-(2-hydroxyethoxy)benzophenone, and mixtures of two or more of the foregoing organic ultraviolet-radiation filter compounds.

Some suitable ultraviolet-radiation filters identified by commercial product codes and with peak absorbencies indicated parenthetically, in some cases, include: UVINUL A Plus available from BASF Ludwigshafen, Germany; ultraviolet-radiation filters DLS 514A, DLS 523A/C, DLS 534B/C, and DLS 548 A-F, available from Crysta-Lyn Chemical Company, Binghampton, N.Y.; ultraviolet-radiation filter PARSOL 1789 (355 nm) available from DSM Nutritional Products, Parsippany, N.J.; ultraviolet-radiation filter UV381A, VIS523A, and VIS548B, available from QCR Solutions Corp., Port St. Lucie, Fla.

Other organic compounds suitable for use as ultraviolet-radiation filters in the practice of example embodiments of the invention will be known or apparent to a person of ordinary skill in the art, in light of this disclosure, or will become known or apparent in the future, as the art develops. Mixtures of any two or more suitable organic ultraviolet-radiation filters can also be employed.

### Visible Light Filter.

Various colorants can be employed as a visible light filter, if a visible light filter is included in the radiation-filtering adhesive layer. For example, dyes, particularly, but not exclusively, transparent dyes can be used. Suitable colorants can absorb visible light at wavelengths of about 500 nm and below, or at other suitable wavelengths. Useful colorants can give the radiation-filtering adhesive layer a colored appearance, for example, orange, red or yellow. One or more colorants can be employed to provide desired visible light filter characteristics. Some other useful properties of colorants employed as visible light filters include transparency, solubility in one or more solvents useful for dissolving or dispersing another constituent or constituents of the radiation-filtering adhesive, reasonable cost and biocompatibility.

Some examples of suitable visible light filters that can be employed alone or in combination, include the following ORASOL dyes available from Kremer Pigmente, New York, N.Y., some product codes for which are shown parenthetically: orange G (94406), orange RG (94408), Brown 2RL (94410), and yellow.

Further suitable dyes include the following dyes, which are identified by product code, and for which some peak absorbencies are shown parenthetically: EPOLIGHT® dyes 5391 (546 nm), 5663 (400 nm), and 5532 (500 nm), available from Epolin, Inc., Newark, N.J.; dyes SDA 6715 (515 nm), SDA 2763 (534 nm), and SDA 8394 (546 nm) available from H.W. Sands Corp., Jupiter, Fla.; dyes DLS 381B; and dyes FHI 5152, and FHI 5202, available from Fabricolor Holding Inn, Paterson, N.J.

Filtration of ultraviolet radiation and of visible light, if visible light filtration is needed, can be provided by a mixture of compounds, or compositions, or by a single compound or composition, for example, an orange-colored dispersion of ferric oxide.

### Solvent.

The solvent or solvents employed in the radiation-filtering adhesive layer can include any carrier solvent or solvents normally supplied by a vendor with any of the ingredients of the radiation-filtering adhesive. The solvent or solvents can include one or more organic solvents and/or water, according to the solution or dispersion properties of the various ingredients of the radiation-filtering adhesive. Some examples of suitable solvents include butanol, butyl acetate, diacetone alcohol, ethanol, 2-ethoxyethanol, ethyl acetate, ethylene glycol, ethyl-3-ethoxy propionate, isopropyl alcohol, methanol, 2-methoxyethanol, methyl isobutyl ketone, methyl tertiary-butyl ether, n-propanol, n-propyl acetate, and water. Other suitable solvents will be known or apparent to a person of ordinary skill in the art, in light of this disclosure, or will become known or apparent in the future.

### Proportions.

The various ingredients of the radiation-filtering adhesive can be present in any of a wide range of proportions. The proportions stated herein are based on the weight of the radiation-filtering adhesive layer, unless the context indicates differently. In general, the radiation-filtering adhesive layer can include a substantial proportion, or a major proportion, of adhesive, a significant proportion of ultraviolet filter material and, optionally, a relatively small proportion of blue-light filter. Other optional ingredients can also be present.

In one example of suitable proportions, the radiation-filtering adhesive includes from about 25 percent to about 98 percent of an adhesive, from about 2 percent to about 98 percent of an ultraviolet filter material and from about 0 percent to about 20 percent of a short wavelength visible light filter, such as a blue light filter, the proportions being based upon the dry weight of the radiation-filtering adhesive.

In another example, the radiation-filtering adhesive includes from about 40 percent to about 95 percent of an adhesive, from about 5 percent to about 60 percent of an organic ultraviolet filter material, from about 2 percent to about 60 percent of an inorganic ultraviolet filter material and from about 0 percent to about 20 percent of a short-wavelength visible light filter, the proportions being based upon the dry weight of the radiation-filtering adhesive.

In a further example, the radiation-filtering adhesive includes from about 45 percent to about 65 percent of an adhesive, from about 20 percent to about 40 percent of an organic ultraviolet filter material, from about 4 percent to about 15 percent of an inorganic ultraviolet filter material, and from about 4 percent to about 15 percent of a short wavelength visible light filter, the proportions being based upon the dry weight of the radiation-filtering adhesive.

The light blocking ingredients of the radiation-filtering adhesive layer, namely, the ultraviolet filter material and the short-wavelength visible light filter, if the latter is present, can include from about 40 percent to about 80 percent of an organic ultraviolet filter material, from about 5 percent to about 30 percent of an inorganic ultraviolet filter material, and from about 0 percent to about 40 percent of a short-wavelength visible light filter, the proportions being based upon the dry weight of the light-blocking ingredients. Alternatively, the proportion of short-wavelength visible light filter can be from about 10 percent to about 30 percent.

The radiation-filtering adhesive can include, initially, sufficient of a solvent, or of a mixture of solvents, to give the radiation-filtering adhesive composition an appropriate viscosity for processing and for application to a suitable substrate, such as, one or more components of an ambient condition history indicator example embodiment of the invention. For example, an initial radiation-filtering adhesive composition can have a proportion of solvent of from about 10 percent to about 80 percent, or from about 20 percent to about 60 percent, or from about 30 percent to about 50 percent by weight based upon the weight of the radiation-filtering adhesive composition. After assembly into an ambient condition history indicator, and curing, for example, by drying, the radiation-filtering adhesive layer can have a residual proportion of solvent of from about 1 percent to about 15 percent, or from about 2 percent to about 5 percent, based on the weight of the radiation-filtering adhesive.

Some illustrative, nonlimiting examples of the preparation of a radiation-filtering adhesive, suitable for use in an ambient condition history indicator example embodiment of the invention, and a comparative example of an ultraviolet-absorbent ink, follow.

### Example 1

A radiation-filtering adhesive of coatable consistency is prepared by thoroughly mixing the following ingredients, in the proportions indicated, and in the sequence listed, which proportions are based on the weight of the radiation-filtering adhesive: 10 parts by weight of solvent-based acrylic copolymer adhesive (dissolved in a mixture of toluene, ethyl acetate, and ethanol, with a solids content of about 44.6 percent by weight) available from Cytec Industries inc. West Paterson, N.J. under the trademark GELVA®, product code 2495;
1.18 parts by weight of 2-ethylhexyl-2-cyano-3,3-diphenylacrylate, which is an organic ultraviolet light absorber available from BASF Aktiengesellschaft, Ludwigshafen, Germany under the trademark UVINUL® 3039;
0.31 parts by weight of orange G dye available under the trademark ORASOL®;
0.61 parts by weight of yellow dye also available under the trademark ORASOL®;
0.84 parts by weight of 2,2′-dihydroxy-4-methoxybenzophenone, an organic ultraviolet light absorber available from Cytec Technology Corp. Wilmington Del. under the trademark CYASORB®, product code UV-24; and
0.50 parts by weight zinc oxide dispersion, an inorganic ultraviolet filter available under the trademark Z-COTE® from BASF Corporation Mount Olive N.J.

The proportions of dye can be adjusted to provide a desired color in the formulation. The ingredients are mixed for about 25 seconds, or until a smooth consistency is obtained, at a room temperature of about 20° C. to about 25° C., and at a speed of about 24 rpm, using a SPEEDMIXER® DAC 150 FVZ-K mixer. During mixing, the various ingredients dissolve and/or disperse in the formulation to provide a homogenous solvent-based radiation-filtering adhesive.

### Example 2

Example 1 is repeated employing the following ones of the ingredients used in Example 1, in the proportions indicated below:
73.4 parts by weight of solvent-based acrylic copolymer adhesive (solids content 44.6 percent by weight);
10.0 parts by weight of 2-ethylhexyl-2-cyano-3,3-diphenylacrylate;
7.1 parts by weight of 2,2′-dihydroxy-4-methoxybenzophenone;
5.2 parts by weight of yellow dye; and
4.3 parts by weight zinc oxide dispersion.

Comparable results are obtained.

### Experiment 1

### Peel Adhesion

To investigate whether the adhesive properties of the acrylic copolymer adhesive are retained after the addition of ultraviolet radiation filters and short wavelength visible light filters, and formulation into a radiation-filtering adhesive as described in Example 1, a peel adhesion test is performed, at a room temperature of about 20° C. to about 25° C. For this test, a number of drawdowns are prepared by applying the acrylic copolymer adhesive alone, as a control, and the radiation-filtering adhesive prepared in Example 1, to 0.05 mm (2 mil) thick polyethylene terephthalate sheets. A bird applicator, number 0.002, is employed to provide a nominal wet film thickness of 0.025 mm (1 mil). The drawdowns have a uniform appearance without apparent defects or voids. The drawdowns are dried to remove residual solvent, and a release liner is applied to the adhesive-coated surfaces. The sheets are then cut into 25 mm by 150 mm (1 in by 6 in) coupons for adhesion testing. A peel adhesion test is performed by removing the liner, applying the coupons to stainless steel plates for 30 minutes, and then measuring the force required to remove the coupon from the plate at an angle of 90° and a speed of 5 mm/s (0.2 in/s) using a Cheminstruments AR1000 peel tester (model number CHEM-AR579). The results, which are shown in Table 1, demonstrate that, in this experiment, the Example 1 radiation-filtering adhesive exhibits a high level of adhesion that is comparable with that of the acrylic copolymer adhesive used alone, notwithstanding the presence of the ultraviolet-radiation filters and the light-filtering dyes. The force required to remove the coupon coated with the radiation-filtering adhesive tested, at 34.9 g/mm, is greater than the force required to remove the coupon coated with acrylic copolymer adhesive alone, which is 30.1 g/mm.

TABLE 1
Peel Adhesion Test Results

| Sample Tested | Peel Adhesion g/mm (g/in) |
|---|---|
| Acrylic copolymer adhesive alone | 30.1 (766) |
| Example 1 formulation | 34.9 (887) |

Accordingly, the radiation-filtering adhesive prepared in Example 1 appears suitable for use in, and can be employed in, an ambient condition history indicator according to the invention, such as ambient condition indicator 50, to attach a transparent layer to a substrate layer bearing an indicator agent, or for other purposes. Example embodiments of the invention can include an ambient condition indicator employing the radiation-filtering adhesive prepared in Example 1. The radiation-filtering adhesive prepared in Example 2 can provide comparable results and is similarly employable.

The following examples and experiments demonstrate the light-blocking characteristics of a exemplary radiation-filtering adhesive according to the invention.

### Comparative Example

To help evaluate the light-blocking characteristics of an exemplary radiation-filtering adhesive layer, a known ultraviolet-absorbent ink, having the composition shown in Table 2, is prepared for comparative purposes. This ultraviolet-absorbent ink is prepared employing the four light-blocking ingredients used in the radiation-filtering adhesive prepared in Example 2, namely, 2-ethylhexyl-2-cyano-3,3-diphenylacrylate, the yellow dye, 2,2′-dihydroxy-4-methoxybenzophenone, and the zinc oxide dispersion, with different relative proportions as shown in Table 2.

These four light-blocking ingredients are thoroughly mixed into a lacquer base prepared from a nitrocellulose film-forming agent, a MODAFLOW® acrylic resin flow modifier (Cytec Technology Corp. Wilmington Del.), a flow agent product code VM2 (Sun Chemical, Parsippany, N.J.), and isopropyl alcohol solvent, in proportions that are also shown in Table 2.

TABLE 2
Ultraviolet-Absorbent Ink Composition

| | Amount | | |
|---|---|---|---|
| | | Solids | Light |
| | Weight | Weight | Blocking |
| Ink Ingredient | (g) | (g) | Percentage |
| UVINUL ® 2-ethylhexyl-2-cyano- | 6.50 | 6.5 | 37.64 |
| 3,3-diphenylacrylate | | | |
| ORASOL yellow dye | 3.38 | 3.38 | 19.57 |
| CYABSORB ® 2,2′-dihydroxy-4- | 4.63 | 4.63 | 26.81 |
| methoxybenzophenone | | | |
| Z-COTE ® zinc oxide dispersion | 2.76 | 2.76 | 15.98 |
| Nitrocellulose solution | 54.87 | 16.46 | * |
| (30% Solids) | | | |
| MODAFLOW ® flow modifier | 0.70 | 0.70 | * |
| Flow agent | 4.00 | 4.00 | * |
| Isopropyl alcohol | 23.17 | 0 | * |
| Total | 100.00 | 38.4 | 100.00 |

The percentage by weight each light blocking ingredient constitutes of the total weight of light-blocking ingredients is also shown in Table 2. In addition, the solids content of the various ingredients is shown. The ultraviolet-absorbent ink prepared in this comparative example has a solids content of 38.4 percent by weight of which about 45 percent by weight is provided by the light-blocking ingredients and about 55 percent is provided by the film forming ingredients in the lacquer base.

### Example 3

A radiation-filtering adhesive layer having similar proportions of light-blocking ingredients to the comparative example, and a balance of GELVA solvent-based acrylic copolymer adhesive, is prepared following the procedure described in Example 1. The ingredients employed, and their proportions, are shown in Table 3.

TABLE 3
Radiation-Filtering Adhesive Composition of Example 3

| | Amount | | |
|---|---|---|---|
| | Weight | Weight | Light |
| | in | of Solid | Blocking |
| Adhesive Ingredient | grams | Material | Percentage |
| UVINUL ® 2-ethylhexyl-2-cyano-3,3- | 1.317 | 1.317 | 37.64% |
| diphenylacrylate | | | |
| ORASOL ® yellow dye | 0.685 | 0.685 | 19.57% |
| CYABSORB ® 2,2′-dihydroxy-4- | 0.938 | 0.938 | 26.81% |
| methoxybenzophenone | | | |
| Z-COTE ® zinc oxide dispersion | 0.559 | 0.559 | 15.98% |
| GELVA ® solvent-based acrylic | 9.63 | 4.29 | * |
| copolymer adhesive (44.6% solids) | | | |
| Total | 13.13 | 7.79 | 100% |

The percentage by weight each light blocking ingredient constitutes of the total weight of light-blocking ingredients is also shown in Table 3, and can be seen to be same as in the comparative example detailed in Table 2. The solids content of the various ingredients is also shown. The radiation-filtering adhesive layer prepared in Example 3 has a solids content of about 59 percent by weight. Further, about 45 percent by weight of the solids is provided by the light-blocking ingredients, which is the same as in the comparative example, and about 55 percent is provided by the adhesive component.

### Experiment 2

### Comparison of Light Blocking Characteristics

In this experiment, the light blocking characteristics of the radiation-filtering adhesive produced in Example 3 are compared with the light blocking characteristics of the ultraviolet-absorbent ink produced in the comparative example. Test samples are prepared using a 1 mil (0.025 mm) bird applicator to coat the radiation-filtering adhesive on to an ultraviolet-blocking transparent polyester dyed orange film (orange-dyed UV-SH 21 PET film. Solutia Inc., St. Louis Mo.). According to the supplier, the dyed orange film is impregnated with ultraviolet blockers using a solvent-based process. The dyed orange film is coated to a dry coat weight of 20±2 g/m² of radiation-filtering adhesive, using the bird applicator used in Experiment 1.

Comparative samples are prepared in a similar manner to the test samples using the ultraviolet-absorbent ink prepared in the comparative example in place of the radiation-filtering adhesive used for the test samples. A sample of the uncoated dyed orange film, one of the comparative samples (ink coated), and one of the test samples (adhesive coated) are examined with a Varian CARY 1E spectrophotometer (available from SpectraLab Scientific Inc., Ontario, Canada) to obtain ultraviolet and visible absorbance spectra at wavelengths from about 200 nm to about 800 nm. A deuterium lamp is used for wavelengths below 350 nm, and a tungsten lamp for wavelengths above 350 nm.

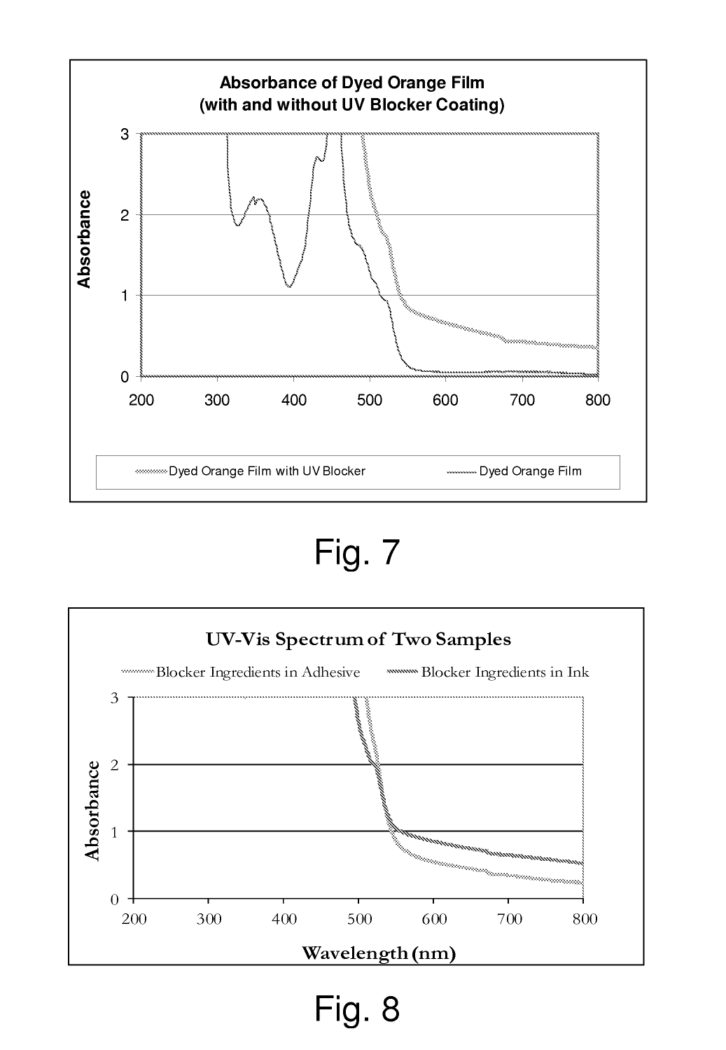

The results of these light absorption studies are shown graphically in FIGS. 7 and 8. FIG. 7 compares the spectra for the uncoated dyed orange film sample and for the comparative sample (ink coated). FIG. 8 compares the spectra for the test sample (adhesive coated) and the comparative sample (ink coated).

Referring to FIG. 7, the wavelength examined is plotted along the x-axis and the absorbance is plotted on the y-axis on a logarithmic scale. The absorbance is −log(transmission) so that an absorbance value of 1 equates with 90.0 percent blocking of the ultraviolet radiation and visible light transmitted through the sample. An absorbance value of 2 equates with 99.0 percent blocking and an absorbance value of 3 equates with 99.9 percent blocking.

In FIG. 7, absorbance values for the uncoated dyed orange film sample are shown by the thinner curve and absorbance values for the comparative sample are shown by the thicker, L-shaped curve. The curve for the uncoated dyed orange film curve exhibits significant wavelength regions between about 300 nm and 500 nm where the absorbance dips below the threshold value of 3 (99.9 percent absorption). In contrast, the comparative sample curve stays above the threshold value of 3 for all wavelengths below about 500 nm, showing the blocking effect of the ultraviolet-absorbent ink coated on the comparative sample.

Referring to FIG. 8, absorbance values for the comparative ultraviolet-absorbent ink sample are shown by the darker L-shaped curve and absorbance values for the radiation-filtering adhesive sample are shown by the lighter L-shaped curve.

In FIG. 8, at wavelengths below about 500 nm, neither the curve for the comparative sample nor that for the test sample appears in the plot area, indicating that the absorbance for each is greater than 3 (greater than 99.9 percent.) At about 500 nm the curve for the comparative ultraviolet-absorbent ink (dark line) appears in the plot area and descends rapidly below the 3 index value to cross the index value of 1 at about 550 nm.

At longer wavelengths, the absorbance by the comparative sample continues to decrease throughout the visible range, at a substantially slower pace.

Still referring to FIG. 8, the curve for the radiation-filtering adhesive test sample (light line) is broadly similar to that for the comparative sample, showing similar absorbencies, with minor differences. The test sample curve shows greater absorbance of wavelengths a few nanometers above 500 nm and somewhat less absorbance of wavelengths above about 550 nm. These small differences do not appear to be material to the performance of an ambient condition indicator, in most instances.

In summary, in this test, both the test sample and the comparative sample absorb, or block, substantially all the ultraviolet radiation and visible light up to about 550 nm and absorb a minor proportion of visible light wavelength above about 550 nm. Thus, the ultraviolet radiation and visible light blocking performance of the radiation-filtering adhesive layer does not appear to be affected by the presence of the adhesive component. Accordingly, the radiation-filtering adhesive layer appears to be suitable for use in an ambient condition indicator to protect the indicator agent from ultraviolet radiation and short wavelength visible light, and the invention includes such an ambient condition indicator.

The ultraviolet radiation filtering and visible light filtering characteristics (also referenced as “light-blocking” characteristics herein) of the radiation-filtering adhesive can be selectively varied by varying the composition of the radiation-filtering adhesive layer, or by adjusting the thickness, of the adhesive layer in the ambient condition indicator, using a suitable coating technique.

### Experiment 3

### Aged Peel Adhesion

To investigate the adhesive performance of the radiation-filtering adhesive prepared in Example 3, a further peel adhesion test is performed, which is generally similar to the peel adhesion test described in Experiment 1, with the differences described in the following paragraphs. Further, additional peel adhesion tests are conducted after aging under various conditions. For these tests, a number of drawdowns are prepared by applying the acrylic copolymer adhesive alone, as a control, and the radiation-filtering adhesive prepared in Example 1, to 0.05 mm (2 mil) thick polyethylene terephthalate sheets. A bird applicator number 0.002 is used to provide a nominal wet film thickness of 0.025 mm (1 mil). The drawdowns have a uniform appearance without apparent defects or voids. The drawdowns are dried to remove residual solvent, and a white release liner (silicone release paper RP-12 from ChemInstruments). is applied to the adhesive-coated surfaces. The sheets are then cut into 25 mm by 125 mm (1 in by 5 in) strips to provide multiple samples for adhesion testing, placed in envelopes and stored under controlled temperature conditions. One batch of samples is held at controlled room temperature of about 20° C. to about 25° C. and another batch is held at about 37° C.

Peel adhesions tests are performed on the samples held at controlled room temperature, initially, and then, variously, after storage for one week, for one month and for two months.

Peel adhesion tests are performed on the samples stored at 37° C. initially, and then after storage variously for one week, for two weeks, for three weeks or for four weeks.

The samples are tested for peel adhesion by removing the release liners, applying the sample strips to stainless steel plates for 30 minutes, and then measuring the force required to remove each sample from the plate at an angle of 90° at a speed of 5 mm/s (0.2 in/s) using a Cheminstruments AR1000 (model number CHEM-AR579) peel tester. The peel tests are conducted at an average ambient relative humidity of about 22 percent. The results for the test samples stored at controlled room temperature are shown in Table 4, and the results for the test samples stored at 37° C. are shown in Table 5. A mean peel value of about 8 g/mm (about 200 g/in), or greater, represents acceptable performance, and a mean peel value of about 16 g/mm (about 400 g/in), or greater, represents good performance.

TABLE 4
Peel Adhesion Test for Samples Stored
at Controlled Room Temperature

| Aging | Mean Peel Value | |
|---|---|---|
| Condition | g/mm (g/in) | Observation |
| Initial | 23.2 (589) | good performance with clean removal |
| 1 Week | 25.6 (651) | good performance with clean removal |
| 1 Month | 27.1 (688) | good performance with clean removal |
| 2 Month | 22.1 (562) | good performance with clean removal |

Referring to Table 4, all the samples held at controlled room temperature exhibit peel values exceeding 16 g/mm (about 400 g/in), which are consistent with good performance, and remove cleanly from the stainless steel plate. The adhesive strength, as measured by the peel values, increases during the first month of storage, and then declines somewhat. After one week of storage, some yellowish-brown color is apparent on the release liners as they are removed from the samples prior to application to the stainless steel plate. This coloring may be due to migration of the light-blocking ingredients, or to the silicone coating on the liner drawing the light-blocking ingredients out of the adhesive, but the phenomenon appears unlikely to be problematic in an ambient condition indicator example embodiment of the invention.

TABLE 5
Peel Adhesion Test for Samples Stored at 37° C.

| Aging | Mean Peel Value | |
|---|---|---|
| Condition | g/mm (g/in) | Observation |
| Initial | 23.2 (589) | good performance with clean removal |
| 1 Week | 19.1 (485) | good performance with clean removal |
| 2 Weeks | 19.1 (485) | good performance with clean removal |
| 3 Weeks | 20.9 (530) | good performance with some residue |
| | | left on the plate |
| 4 Weeks | 29.7 (755) | good performance with some residue |
| | | left on the plate |

Referring to Table 5, all the samples held at 37° C. also exhibit peel values exceeding 16 g/mm (about 400 Win), which are consistent with good performance. Samples stored for up to two weeks also remove cleanly from the stainless steel plate. Samples stored longer, for three or four weeks, leave some residue on the stainless steel plate. The adhesive strength, as measured by the peel values, declines during the first week of storage, and then increases, reaching a value higher than the initial value after four weeks. After one week of storage, some yellowish-brown color is also apparent on the release liners. This coloring increases with increasing storage but the phenomenon appears unlikely to be problematic in an ambient condition indicator according to the invention.

In certain example embodiments, an ambient condition history indicator according to the invention can include, in addition to a radiation-filtering adhesive layer, a layer of ultraviolet-absorbent ink extending over the entire area of the indicator agent, to protect the indicator agent from ultraviolet radiation, if desired. Such an example embodiment of ambient condition history indicator can be useful to provide an additional level of security against interference with proper functioning of the indicator agent from ultraviolet radiation.

The ultraviolet-absorbent ink layer can be located between the transparent layer, if present, and the radiation-filtering adhesive layer, or between the radiation-filtering adhesive layer and the substrate and/or substrate-contacting components, such as the indicator element and, optionally, the reference zone, if a reference zone is present. If the ultraviolet-absorbent ink is located between the radiation-filtering adhesive layer and the substrate and/or substrate-contacting components, the radiation-filtering adhesive layer may not make direct contact with the indicator agent.

The ultraviolet-absorbent ink layer can be a continuous layer and, optionally, can be co-extensive with the substrate or the transparent layer. Alternatively, the ultraviolet-absorbent ink layer can be a spot or patch, or other limited area, which overlies or covers the indicator agent and, optionally, an adjacent reference zone, if present. The spot or patch of ultraviolet-absorbent ink can be limited in extent so as to not reach the edge of the ambient condition history indicator, and thus can avoid a heightened risk of delamination. For example, the spot or patch of ultraviolet-absorbent ink can be limited in area to no more than about ten percent greater than the area of the indicator agent, or of the indicator agent and the color reference zone, if present.

Including an ultraviolet-absorbent ink layer in the ambient condition history indicator can be useful to provide additional ultraviolet protection to cover occasional production defects, such as voids, or thinning, of the radiation-filtering adhesive layer, that might occur, for example, during high-speed mass production. Also, an ultraviolet-absorbent ink layer can provide additional ultraviolet protection enabling a particularly high level of ultraviolet radiation protection of the indicator agent to be achieved, if desired.

The ultraviolet-absorbent ink layer can have any of a variety of compositions that can absorb ultraviolet radiation, and optionally, also undesired visible light, and that are suitable for use in an ambient condition history indicator according to the invention. For example, the ultraviolet-absorbent ink layer can have a composition as described in Prusik et al. '830.

The ultraviolet-absorbent ink layer can include any one or more of a film-forming agent, for example, nitrocellulose, an ultraviolet-radiation filter, and a light filter. The ultraviolet-radiation filter and the light filter, if present, can be as described herein. A suitable organic, or aqueous solvent, or dispersion medium, can be employed in the ink to facilitate application of the ultraviolet-absorbent ink during manufacture of the ambient condition history indicator, in which case the ultraviolet-absorbent ink layer can include residual quantities of solvent.

Some example embodiments of the ultraviolet-absorbent ink layer, if present, can have a composition generally similar to that of the radiation-filtering adhesive layer with the difference that the ultraviolet-absorbent ink composition includes a film forming agent, and lacks an adhesive that could impede application of the ultraviolet-absorbent ink. Similar proportions of the various ingredients to the proportions described herein can also be employed, the proportion of film-forming agent in the ultraviolet-absorbent ink being similar to the proportion of adhesive in the radiation-filtering adhesive.

Where an ambient condition history indicator example embodiment of the invention includes an ultraviolet-absorbent ink, and the ambient condition history indicator includes more than one filter to filter ultraviolet radiation or visible light, the filters can be distributed between the ultraviolet-absorbent ink layer and the radiation-filtering adhesive layer in a variety of different ways providing a variety of different choices in the design of the ambient condition history indicator. For example, equal proportions of each filter can be present in each of the two layers. Or one of the two layers can include up to about three times the quantity of a particular filter that is present in the other of the two layers.

Alternatively, one filter, for example an ultraviolet-radiation filter, can be entirely present in one of the two layers, and another filter, or filters, or all other filters, for example, a visible light filter, can be present entirely in the other layer. In a further example, an inorganic ultraviolet-radiation filter, or filters, can be present in the ultraviolet-absorbent ink layer only, and an organic ultraviolet-radiation filter, or filters, can be present in the radiation-filtering adhesive layer only. In a further example, the organic ultraviolet-radiation filter can be distributed between the ultraviolet-absorbent ink layer and the radiation-filtering adhesive layer with some of the ultraviolet-radiation filter being present in each of the two layers. In these examples, one or more visible light filters, optionally, can be present in one of the two layers only, or can be distributed between the two layers. Further, some of a filter can be in one layer and the balance of the filter can be in the other of the two layers.

Thus, including an ultraviolet-absorbent ink layer in an ambient condition history indicator example embodiment of the invention also can provide flexibility in the formulation of the radiation-filtering adhesive layer enabling a lower concentration of one or more ingredients to be employed. Such flexibility may be helpful in addressing a manufacturing problem, or a formulation, or other problem, that might occur in a particular application.

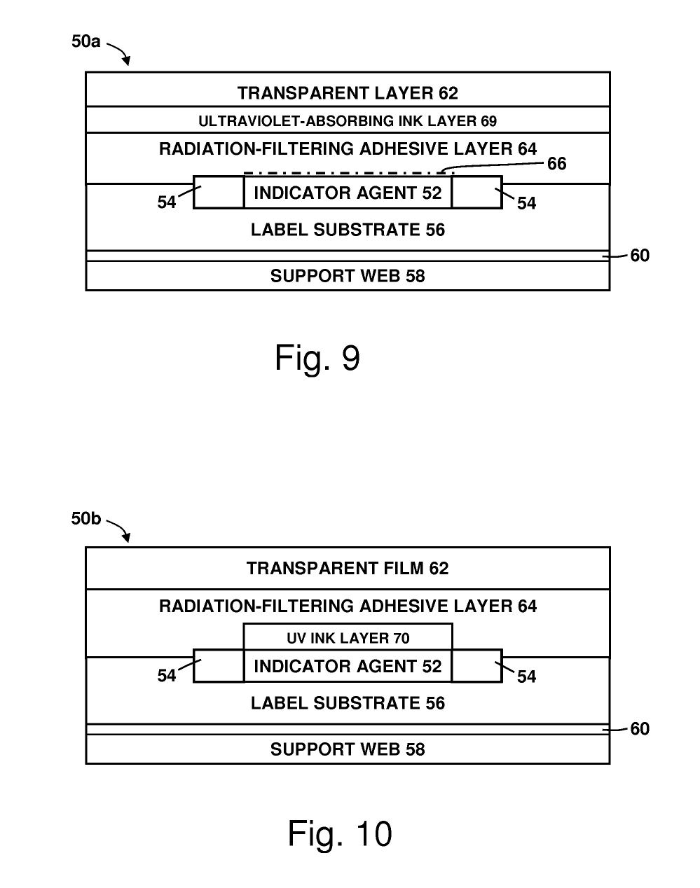

FIGS. 9 and 10 show two examples of ambient condition history indicator 50, referenced 50a and 50b, respectively, that have been modified to include an ultraviolet-absorbent ink layer.

Referring to FIG. 9, ambient condition history indicator 50a includes an ultraviolet-absorbent ink layer 69 disposed between transparent layer 62 and radiation-filtering adhesive layer 64. Ultraviolet-absorbent ink layer 69 is disposed over indicator agent 52 to absorb ultraviolet radiation and/or short wavelength visible light and protect indicator agent 52 from same. Ultraviolet-absorbent ink layer 69 can be continuous and coextensive with transparent layer 62 and radiation-filtering adhesive layer 64, as shown, or can have other configurations.

Referring to FIG. 10, ambient condition history indicator 50b includes an ultraviolet-absorbent ink layer 70 disposed between radiation-filtering adhesive layer 64 and indicator agent 52 and over indicator agent 52 where it can absorb ultraviolet radiation and/or short wavelength visible light to protect indicator agent 52 from same. Ultraviolet-absorbent ink layer 70 can be continuous and coextensive with indicator agent 52, as shown. Alternatively, depending upon how color reference zone 54 is applied, ultraviolet-absorbent ink layer 70 can extend over color reference zone 54, or can extend beneath color reference zone 54, or can have other configurations.

The invention includes a combination indicator as described in U.S. Pat. No. 7,490,575 to Taylor et al. that includes a time-temperature indicator, wherein the time-temperature indicator is replaced by an ambient condition history indicator example embodiment of the present invention.

Further, the invention includes a combination RFID tag as described in U.S. Pat. No. 7,209,042 to Martin et al. that includes a visually readable environmental condition exposure indicator, wherein the visually readable environmental condition exposure indicator is replaced by an ambient condition history indicator example embodiment of the present invention.

The invention also includes a transparent layer, film, sheet, or other transparent or opaque substrate bearing one or more deposits, or a layer, of a transparent ultraviolet-radiation-filtering adhesive as described herein, for example, radiation-filtering adhesive layer 64. Such an adhesive-bearing transparent layer can be applied to an ultraviolet-sensitive indicator (that is not intended to indicate ultraviolet exposure), or other useful device, to provide good protection from ultraviolet radiation in a simple manner. The degree of protection provided can be varied by suitable adjustment of the parameters of the adhesive, as described herein. In some cases, more ultraviolet radiation can be blocked, or filtered out than can be achieved with a self-supporting transparent film incorporating one or more ultraviolet-blocking ingredients.

In addition, various known ambient condition history indicators can be protected from ultraviolet radiation by incorporating a radiation-filtering adhesive layer as described herein, thereby providing additional example embodiments of the present invention. Some examples of devices that can be so protected include: a temperature-activatable time-temperature indicator as described in U.S. patent application Ser. No. 13/238,686 by Huffman et al.; a threshold indicator as described in U.S. Pat. No. 5,709,472 to Prusik et al.; an excess temperature indicator as described in U.S. Pat. No. 7,517,146 to Smith et al.; a freeze indicator as described in U.S. Pat. No. 7,343,872; 7,571,695; or 7,624,698 to Taylor et al. or in U.S. Patent Application Publication No. US 2011/0209658 to Smith et al.; a combination indicator as described in U.S. Pat. No. 7,490,575 to Taylor et al.; a combination RFID tag as described in U.S. Pat. No. 7,209,042 to Martin et al.; and a product label as described in U.S. Patent Application Publication No. US 2011/0258130 by Grabiner et al. or U.S. patent application Ser. No. 13/276,543, also by Grabiner et al. The entire disclosure of each of said patents and patent applications is incorporated by reference herein.

Ambient condition history indicators according to the invention can usefully be employed to monitor the condition of any of a wide range of host products that can be condition-sensitive, or perishable, including: temperature-sensitive health care products, for example, vaccines, drugs, medicaments, pharmaceuticals, pharmaceuticals including a polypeptide, a nucleic acid or cellular material, medical devices, prophylactics and the like; biological materials for industrial or therapeutic uses, for example cultures, organs, and other human or animal body parts, blood and perishable blood products; diagnostic devices, diagnostic kits containing perishables and perishable diagnostic ingredients; batteries, battery-containing devices, battery-containing appliances; fresh or prepared foodstuffs, including fish, meats, dairy products, fruits, vegetables, baked goods, desserts, and the like; food service products, including restaurant service foods; gourmet products; perishable animal foods; cut and uncut flowers; cosmetics, for example cosmetics containing biologicals or other labile or perishable ingredients; beauty aids; perishable industrial products; paint; solder; perishable munitions and ordnance; and perishable decontamination packs and products.

An ambient condition history indicator according to the invention can be associated with a host product in a variety of ways, for example by adhering, tying, looping, stapling or otherwise affixing the ambient condition history indicator, or a label or tag embodying the ambient condition history indicator, to a desired host product, either directly to a host product, or to a package containing the host product, or to a package, carton, box or other container containing a number of host product items. Also, the ambient condition history indicator, label, or tag, can be inserted in a host product package, carton, or other container for one or host product items.

Benefits.

The invention can be embodied in ambient condition history indicators for monitoring exposure to heat or other environmental conditions, which ambient condition history indicators can tolerate ambient ultraviolet radiation, can resist interference from short-wavelength visible light, if desired, are robust, resistant to delamination and easy to manufacture. Some example embodiments are suitable for long-term applications, and may have characteristics suitable for use with host products having a shelf life in excess of four year, for example, five years or seven years or more. The invention also provides simple and efficient methods for making such ambient condition history indicators.

The following example embodiments are specifically contemplated:

### Example Embodiment 1

An optically readable ambient condition history indicator comprising:
a substrate having a surface;
an indicator agent on the substrate surface, the indicator agent being capable of changing appearance irreversibly in response to historical exposure to an ambient condition;
a transparent layer overlying the indicator agent and at least a portion of the substrate surface, the transparent layer being subject to exposure to environmental ultraviolet radiation and the indicator appearance change being optically readable through the transparent layer;
a radiation-filtering adhesive layer overlying the indicator agent, wherein the radiation-filtering adhesive layer contacts the transparent layer, secures the transparent layer to the substrate surface, extends over the indicator agent, and comprises:
   an adhesive; and
   an ultraviolet radiation filter;
wherein the radiation-filtering adhesive layer can filter out ultraviolet radiation transmitted through the transparent layer.

### Example Embodiment 2

An ambient condition history indicator according to example embodiment 1 wherein the indicator agent occupies a portion of the substrate surface, the substrate surface has an unoccupied portion, and the radiation-filtering adhesive layer also overlies the unoccupied portion of the substrate surface.

### Example Embodiment 3

An ambient condition history indicator according to example embodiment 2 comprising a contact area where the radiation-filtering adhesive layer contacts the transparent layer and contacts the indicator agent also wherein the contact area is at least coextensive with the occupied portion of the substrate surface.

### Example Embodiment 4

An ambient condition history indicator according to example embodiment 1, 2 or 3 wherein the transparent layer and the radiation-filtering adhesive layer extend at least to the periphery of the substrate.

### Example Embodiment 5

An ambient condition history indicator according to any preceding example embodiment wherein the transparent layer is transmissive to at least about 50 percent of ultraviolet radiation incident on the transparent layer.

### Example Embodiment 6

An ambient condition history indicator according to any preceding example embodiment wherein the radiation-filtering adhesive layer can filter out at least about 70 percent, at least about 90 percent, or at least about 95 percent, or at least about 99 percent of the ultraviolet energy incident on the radiation-filtering adhesive layer in a waveband of from about 200 nm to about 400 nm.

### Example Embodiment 7

An ambient condition history indicator according to any preceding example embodiment wherein the transparent layer is transmissive to at least about 20 percent of light energy incident on the transparent layer in a waveband from about 400 nm to about 540 nm.

### Example Embodiment 8

An ambient condition history indicator according to any preceding example embodiment wherein the radiation-filtering adhesive layer comprises a light filter to filter out short wavelength visible light.

### Example Embodiment 9

An ambient condition history indicator according to example embodiment 8 wherein the light filter is transmissive to visible light having a longer wavelength than the filtered-out short wavelength visible light.

### Example Embodiment 10

An ambient condition history indicator according to any preceding example embodiment wherein the radiation-filtering adhesive layer can transmit at least about 70 percent, at least about 90 percent, or at least about 95 percent of the light energy reflected from the indicator agent in a waveband of from about 400 nm to about 700 nm.

### Example Embodiment 11

An ambient condition history indicator according to any preceding example embodiment wherein the adhesive is selected from the group consisting of a synthetic monomer adhesive, a synthetic polymer adhesive, a solvent-based adhesive, a polymer dispersion adhesive, a pressure-sensitive adhesive, a contact adhesive, a hot-melt adhesive, a multi-component adhesive, a heat-curing adhesive, a moisture-curing adhesive, a mixture of any two or more compatible ones of the foregoing adhesives, or is selected from the group consisting of acrylonitrile, cyanoacrylate, acrylic, ethylene-vinyl acetate, polyvinyl alcohol, polyvinyl acetate, polyvinyl chloride, polyvinyl chloride emulsion, styrene acrylic copolymer, phenol formaldehyde resin, polyamide, polyester, epoxy, polyethylene, polypropylene, polysulfide, polyurethane, aliphatic resin, polyvinylpyrrolidone, urea-formaldehyde, starch, latex, resorcinol, and silicone adhesives, and mixtures of any two or more compatible ones of the foregoing adhesives.

### Example Embodiment 12

An ambient condition history indicator according to any preceding example embodiment wherein the ultraviolet-radiation filter comprises a particulate dispersion of ultraviolet-filtering metal oxide particles.

### Example Embodiment 13

An ambient condition history indicator according to any preceding example embodiment wherein the ultraviolet radiation filter is selected from the group consisting of zinc oxide, titanium dioxide, iron oxide, octylmethoxy cinnamate, octyl salicylate, octocrylene, oxybenzone, 2-ethylhexyl N,N-dimethylaminobenzoate, p-aminobenzoic acid, 2-phenyl-benzamidazole-5-sulfonic acid, homomethyl salicylate, avobenzone, DEA p-methoxycinnamate, octylmethoxy cinnamate, 4,4′-methoxy-t-butyldibenzoylmethane, 4-isopropyldibenzoylmethane, 3-(4-methylbenzylidene) camphor, 3-benzylidene camphor, 4-N,N-dimethylaminobenzoic acid ester, 2,4-dihydroxybenzophenone, 2-hydroxy-4-(2-hydroxyethoxy)benzophenone, 4-hydroxydibenzoyl-methane, 4-(2-hydroxyethoxy)dibenzoylmethane, 4-N,N-di(2 ethylhexyl)-aminobenzoic acid ester, 4-N,N-(2-ethylhexyl)methylaminobenzoic acid ester, 4-N,N-(2-hydroxyethoxy)benzophenone, and mixtures of two or more of the foregoing ultraviolet-radiation filters.

### Example Embodiment 14

An ambient condition history indicator according to any preceding example embodiment wherein the indicator agent comprises a diacetylenic compound.

### Example Embodiment 15

An ambient condition history indicator according to any one of example embodiments 1 to 7 wherein the transparent layer comprises a light filter to block blue light, the light filter being transmissive to red light.

### Example Embodiment 16

An ambient condition history indicator according to any preceding example embodiment wherein the indicator agent comprises an active diacetylenic compound capable of changing appearance in response to cumulative exposure to temperature over time.

### Example Embodiment 17

An ambient condition history indicator according to any preceding example embodiment wherein the radiation-filtering adhesive layer can exhibit a peel value of at least about 16 g/mm as determined at an angle of 90° and a speed of 5 mm/s using a Cheminstruments AR1000 peel tester.

### Example Embodiment 18

An ambient condition history indicator according to any preceding example embodiment comprising a layer of an ultraviolet-absorbent ink extending over the indicator agent.

### Example Embodiment 19

An ambient condition history indicator according to any preceding example embodiment and a host product wherein the ambient condition history indicator is associated with the host product to monitor the exposure of the host product to an ambient condition.

### Example Embodiment 20

A method of making an optically readable ambient condition history indicator comprising:
applying an indicator agent to a substrate surface, the indicator agent being capable of changing appearance in response to exposure to an ambient condition,
applying a radiation-filtering adhesive to a transparent layer, the radiation-filtering adhesive comprising an adhesive component and an ultraviolet radiation filter wherein the adhesive component can filter out ultraviolet radiation transmitted by the transparent layer to protect the indicator agent from exposure to the ultraviolet radiation; and
overlaying the transparent layer bearing the radiation-filtering adhesive on the substrate surface bearing the indicator agent so that the radiation-filtering adhesive contacts the indicator agent.

Particular example embodiments of ambient condition history indicator according to the invention can have any invention-related component configuration that is described herein, or is shown in the accompanying drawings, and can employ any compatible ones of the useful materials described herein. Further, an ambient condition history indicator example embodiment of the invention can include a combination of any technical feature or features recited in one of the appended claims with a compatible technical feature recited in any other claim or claims, or described in the specification.

### Disclosures Incorporated.

Unless incorporated elsewhere herein, the entire disclosure of each U.S. patent and patent application, of each foreign or international patent publication, of any other publication and of any unpublished patent application identified in this specification is incorporated by reference herein, in its entirety, for all purposes. Should there appear to be a conflict between the meaning of a term employed in the description of the invention in this specification and the usage in material incorporated by reference from another document, the meaning of the term as used herein is intended to prevail. Any reference to an “invention” in any incorporated disclosure is to be understood to refer to the invention described, or claimed, in the disclosure incorporated.

### About the Description.

The detailed description herein is to be read in light of and in combination with the preceding background and invention summary descriptions wherein partial or complete information regarding the invention, or regarding modifications, alternatives or useful example embodiments of the invention may also be set forth, or suggested, as will be apparent to one skilled in the art.

The terms “include,” “have,” “has,” and “contain,” and their various grammatical forms, are to be understood as being open-ended and not excluding additional, unrecited elements or method steps.

Throughout the description, where compositions instruments, devices apparatus, systems, or processes are described as having, including, or comprising specific components or elements, or in the case of processes, specific steps, it is contemplated that compositions instruments, devices apparatus, systems, or processes according to the present invention can also consist essentially of, or consist of, the recited components, elements or steps.

In the application, where an element or component is said to be included in and/or selected from a list or group of recited elements or components, it should be understood that the element or component can be any one of the recited elements or components, or can be selected from a group consisting of two or more of the recited elements or components.

The use of the singular herein is intended to include the plural (and vice versa) unless the context indicates otherwise.

Also, where the term “about”, “approximate”, “approximately”, or a similar term, is used before a quantitative value, the specific quantitative value itself is to be understood to be included, and to be explicitly recited, unless the description specifically states otherwise.

The term “polymer”, and its linguistic variants, is used herein to include copolymers, as well as homopolymers, unless the context indicates otherwise, for example, by describing or referencing one or more specific homopolymers.

With regard to processes, it is to be understood that the order of steps or order for performing certain actions is immaterial so long as the described process remains operable. Moreover, two or more steps or actions may be conducted simultaneously, unless the context indicates otherwise. In addition, any proportions recited herein are to be understood to be proportions by weight, based upon the weight of the relevant composition, unless the context indicates otherwise.

Merely because a document may have been cited in this application, no admission is made that the field of the document, which may be quite different from that of the invention, is analogous to the field or fields of the present invention.

The description of the invention is to be understood as including combinations of the various elements of the invention, and of their disclosed or suggested alternatives, including alternatives disclosed, implied or suggested in any one or more of the various methods, products, compositions, systems, apparatus, instruments, aspects, embodiments, examples described in the specification or drawings, if any, and to include any other written or illustrated combination or grouping of elements of the invention or of the possible practice of example embodiments of the invention, except for groups or combinations of elements that are incompatible with, or contrary to the purposes of the invention, as will be or become apparent to a person of ordinary skill

### Scope of the Invention.

The present invention includes the examples and embodiments described herein and other specific forms of the invention that embody the spirit or essential characteristics of the invention or of the respective described examples or embodiments. The foregoing examples and embodiments are in all respects intended to be illustrative of the invention described herein. It is to be understood that many and various modifications of the invention, or of an example or embodiment of the invention described herein will be apparent to those of ordinary skill in the relevant art, or may become apparent as the art develops, in the light of the foregoing description. Such modifications are contemplated as being within the spirit and scope of the invention or inventions disclosed herein.

1. An optically readable ambient condition history indicator comprising:
a substrate having a surface;
an indicator agent on the substrate surface, the indicator agent being capable of changing appearance irreversibly in response to historical exposure to an ambient condition;
a transparent layer overlying the indicator agent and at least a portion of the substrate surface, the transparent layer being subject to exposure to environmental ultraviolet radiation and the indicator appearance change being optically readable through the transparent layer;
a radiation-filtering adhesive layer overlying the indicator agent, wherein the radiation-filtering adhesive layer contacts the transparent layer, secures the transparent layer to the substrate surface, extends over the indicator agent, and comprises:
an adhesive; and
an ultraviolet radiation filter;
wherein the radiation-filtering adhesive layer can filter out ultraviolet radiation transmitted through the transparent layer.

2. An ambient condition history indicator according to claim 1 wherein the indicator agent occupies a portion of the substrate surface, the substrate surface has an unoccupied portion, and the radiation-filtering adhesive layer also overlies the unoccupied portion of the substrate surface.

3. An ambient condition history indicator according to claim 2 comprising a contact area where the radiation-filtering adhesive layer contacts the transparent layer and contacts the indicator agent also wherein the contact area is at least coextensive with the occupied portion of the substrate surface.

4. An ambient condition history indicator according to claim 1 wherein the transparent layer and the radiation-filtering adhesive layer extend at least to the periphery of the substrate.

5. An ambient condition history indicator according to claim 1 wherein the transparent layer is transmissive to at least about 50 percent of ultraviolet radiation incident on the transparent layer.

6. An ambient condition history indicator according to claim 1 wherein the radiation-filtering adhesive layer can filter out at least about 70 percent of the ultraviolet energy incident on the radiation-filtering adhesive layer in a waveband of from about 200 nm to about 400 nm.

7. An ambient condition history indicator according to claim 1 wherein the transparent layer is transmissive to at least about 20 percent of light energy incident on the transparent layer in a waveband from about 400 nm to about 540 nm.

8. An ambient condition history indicator according to claim 1 wherein the radiation-filtering adhesive layer comprises a light filter to filter out short wavelength visible light.

9. An ambient condition history indicator according to claim 8 wherein the light filter is transmissive to visible light having a longer wavelength than the filtered-out short wavelength visible light.

10. An ambient condition history indicator according to claim 1 wherein the radiation-filtering adhesive layer can transmit at least about 70 percent of the light energy reflected from the indicator agent in a waveband of from about 400 nm to about 700 nm.

11. An ambient condition history indicator according to claim 1 wherein the adhesive is selected from the group consisting of a synthetic monomer adhesive, a synthetic polymer adhesive, a solvent-based adhesive, a polymer dispersion adhesive, a pressure-sensitive adhesive, a contact adhesive, a hot-melt adhesive, a multi-component adhesive, a heat-curing adhesive, a moisture-curing adhesive, a mixture of any two or more compatible ones of the foregoing adhesives, or is selected from the group consisting of acrylonitrile, cyanoacrylate, acrylic, ethylene-vinyl acetate, polyvinyl alcohol, polyvinyl acetate, polyvinyl chloride, polyvinyl chloride emulsion, styrene acrylic copolymer, phenol formaldehyde resin, polyamide, polyester, epoxy, polyethylene, polypropylene, polysulfide, polyurethane, aliphatic resin, polyvinylpyrrolidone, urea-formaldehyde, starch, latex, resorcinol, and silicone adhesives, and mixtures of any two or more compatible ones of the foregoing adhesives.

12. An ambient condition history indicator according to claim 1 wherein the ultraviolet-radiation filter comprises a particulate dispersion of ultraviolet-filtering metal oxide particles.

13. An ambient condition history indicator according to claim 1 wherein the ultraviolet radiation filter is selected from the group consisting of zinc oxide, titanium dioxide, iron oxide, octylmethoxy cinnamate, octyl salicylate, octocrylene, oxybenzone, 2-ethylhexyl N,N-dimethylaminobenzoate, p-aminobenzoic acid, 2-phenyl-benzamidazole-5-sulfonic acid, homomethyl salicylate, avobenzone, DEA p-methoxycinnamate, octylmethoxy cinnamate, 4,4′-methoxy-t-butyldibenzoylmethane, 4-isopropyldibenzoylmethane, 3-(4-methylbenzylidene) camphor, 3-benzylidene camphor, 4-N,N-dimethylaminobenzoic acid ester, 2,4-dihydroxybenzophenone, 2-hydroxy-4-(2-hydroxyethoxy)benzophenone, 4-hydroxydibenzoyl-methane, 4-(2-hydroxyethoxy)dibenzoylmethane, 4-N,N-di(2-ethylhexyl)-aminobenzoic acid ester, 4-N,N-(2-ethylhexyl)methylaminobenzoic acid ester, 4-N,N-(2-hydroxyethoxy)benzophenone, and mixtures of two or more of the foregoing ultraviolet-radiation filters.

14. An ambient condition history indicator according to claim 1 wherein the indicator agent comprises a diacetylenic compound.

15. An ambient condition history indicator according to claim 1 wherein the transparent layer comprises a light filter to block blue light, the light filter being transmissive to red light.

16. An ambient condition history indicator according to claim 1 wherein the indicator agent comprises an active diacetylenic compound capable of changing appearance in response to cumulative exposure to temperature over time.

17. An ambient condition history indicator according to claim 1 wherein the radiation-filtering adhesive layer can exhibit a peel value of at least about 16 g/mm as determined at an angle of 90° and a speed of 5 mm/s using a Cheminstruments AR1000 peel tester.

18. An ambient condition history indicator according to claim 1 comprising a layer of an ultraviolet-absorbent ink extending over the indicator agent.

19. An ambient condition history indicator according to claim 1 and a host product wherein the ambient condition history indicator is associated with the host product to monitor the exposure of the host product to an ambient condition.

20. A method of making an optically readable ambient condition history indicator comprising:
applying an indicator agent to a substrate surface, the indicator agent being capable of changing appearance in response to exposure to an ambient condition,
applying a radiation-filtering adhesive to a transparent layer, the radiation-filtering adhesive comprising an adhesive component and an ultraviolet radiation filter wherein the adhesive component can filter out ultraviolet radiation transmitted by the transparent layer to protect the indicator agent from exposure to the ultraviolet radiation; and
overlaying the transparent layer bearing the radiation-filtering adhesive on the substrate surface bearing the indicator agent so that the radiation-filtering adhesive contacts the indicator agent.
